(19) United States
(12) Patent Application Publication
(10) Pub. No.: US 2015/0149778 A1
(43) Pub. Date: May 28, 2015

(54) CONTENT RECEPTION APPARATUS AND METHOD, AND CONTENT TRANSMISSION APPARATUS AND METHOD

(71) Applicant: SONY CORPORATION, Tokyo (JP)

(72) Inventor: TAKEHIKO NAKANO, KANAGAWA (JP)

(21) Appl. No.: 14/538,442

(22) Filed: Nov. 11, 2014

(30) Foreign Application Priority Data
Nov. 22, 2013 (JP) 2013-241552

(51) Int. Cl. H04L 29/06; G06F 21/10

(52) U.S. Cl. CPC H04L 63/0869; G06F 21/10; H04L 63/061; H04L 63/0823; G06F 2221/07
USPC 713/169

(57) ABSTRACT

A content reception apparatus includes: a communication unit that communicates with a content transmission apparatus; an authenticating unit that performs mutual authentication with the content transmission apparatus; a content recording unit that records content; and a content reproduction output unit that reproduces the content, wherein the content is received from the content transmission apparatus and is recorded in the content recording unit after the authenticating unit performs first authentication with the content transmission apparatus, and the content recorded in the content recording unit is reproduced after the authenticating unit performs a process including second authentication with the content transmission apparatus.

### CROSS REFERENCE TO RELATED APPLICATION(S)

This application claims the benefit of Japanese Priority Patent Application JP 2013-241552 filed on Nov. 22, 2013, the entire contents of which are incorporated herein by reference.

### TECHNICAL FIELD

The technique disclosed in this specification relates to a content reception apparatus and a content reception method that use received content under a predetermined limit, and to a content transmission apparatus and a content transmission method that put a predetermined limit on use of transmitted content.

### BACKGROUND ART

It is relatively easy to duplicate or modify digitalized content in an unauthorized manner. Therefore, there is a need for a copyright protection mechanism for preventing unauthorized use of transmitted content while allowing personal or household use of the content. Examples of industry-standard techniques for protecting transmitted digital content include DTCP (Digital Transmission Content Protection) developed by the DTLA (Digital Transmission Licensing Administrator).

In DTCP, a protocol for authentication between devices at a time of content transmission and a protocol for encrypted content transmission are established. According to the rules in summary, a DTCP-compliant device is prohibited from transmitting easy-to-handle compressed content in an unencrypted state outside the device, the key exchange necessary for decrypting encrypted content should be performed in accordance with the predetermined mutual authentication and key exchange (AKE) algorithm, and the types of devices allowed to perform the key exchange through an AKE command should be limited, for example.

Initially, DTCP defined content transmission in a home network using transmission channels compliant with IEEE1394 or the like. According to the DLNA (Digital Living Network Alliance), which defines interconnections between different kinds of information devices in households, for example, DTCP is applied to encryption and transmission of compressed content. In recent years, the movement to enable the use of digital content stored in a household from a remote place via an IP (Internet Protocol) network (remote access) has become active. In view of this, DTCP+, which has the remote access function of DTCP-IP (DTCP mapping to IP), is now being developed by applying the DTCP technique to IP networks.

There is a demand for control to prevent unlimited public use of broadcast content and commercial content such as movies that are stored in home servers and can be viewed from remote places with mobile terminals such as portable telephones and multifunctional terminals.

According to DTCP+, remote access to a household server is limited to the terminals registered with the server, so as to prevent third parties from using content. Also, when the terminals are registered with the household server, the round trip time (RTT) of a command is limited to a maximum of seven milliseconds, and the packet TTL (Time To Live) represented by the number of hops of the IP router is set.

For example, there has been a suggested content transmission apparatus that transmits encrypted content with shared key data only when the time required for confirmation of reception of an authentication request or an authentication response transmitted at a time of authentication does not exceed a certain upper limit value, and registers the address information and the device information unique to the device therein so that the encrypted content will be transmitted without any upper time limit value at a time of retransmission (see PTL 1, for example).

Also, there has been a suggested content transmission system that lifts up a limit on the above described RTT and TTL to allow sharing of the remote access key in the authentication procedures at a time of remote access, but limits remote access from a large indefinite number of people by requiring advance registration of remote access terminals with the server, putting a limit on the number of users allowed to remotely access content, and putting a limit on the number of people sharing the key (see PTL 2, for example).

According to the current DTCP+ standard, however, once a terminal is registered with a household server, the user of the terminal can permanently use the content in the home server through remote access without re-registration. Therefore, once a third party's terminal is registered with the server, the third party can permanently use the content in the home server.

### CITATION LIST

### Patent Literature

[PTL 1]
JP 2005-204094 A
[PTL 2]
JP 2011-82952 A

### SUMMARY

### Technical Problem

The technique disclosed in this specification is to provide a preferred content reception apparatus and a preferred content reception method that can appropriately use received content under a predetermined limit.

The technique disclosed in this specification is to further provide a preferred content transmission apparatus and a preferred content transmission method that can put a predetermined limit on the use of transmitted content.

### Solution to Problem

The technique disclosed in this specification has been developed by taking into the above problems into account, and relates to a content reception apparatus that includes: a communication unit that communicates with a content transmission apparatus; an authenticating unit that performs mutual authentication with the content transmission apparatus; a content recording unit that records content; and a content reproduction output unit that reproduces the content, wherein the content is received from the content transmission apparatus and is recorded in the content recording unit after the authenticating unit performs first authentication with the content transmission apparatus, and the content recorded in the content recording unit is reproduced after the authenticating unit performs a process including second authentication with the content transmission apparatus.

In the content reception apparatus, the content recorded in the content recording unit is controlled not to be reproduced when the exchange key obtained through the process including the second authentication is not held.

In the content reception apparatus, the content is encrypted with a secret key unique to the content reception apparatus and is recorded in the content recording unit.

In the content reception apparatus, when the content is received from the content transmission apparatus as a result of the first authentication performed by the authenticating unit, information to be used in a reproduction process after the process including the second authentication is performed is stored.

In the content reception apparatus, first identification information of the content transmission apparatus is stored as the information to be used in the reproduction process, and the authenticating unit performs the process including the second authentication with the content transmission apparatus having the stored first identification information.

In the content reception apparatus, second identification information included in a device certificate received from the content transmission apparatus in the first authentication is stored as the information to be used in the reproduction process, and the authenticating unit determines whether identification information included in a device certificate received from the content transmission apparatus in the second authentication is the same as the stored identification information.

The content reception apparatus further includes a content information acquiring unit that acquires content information including the URL of content and UI information useful for content selection. The URL of the content and the UI information are stored as the information to be used in the reproduction process.

In the content reception apparatus, the authenticating unit performs the process including the second authentication with the content transmission apparatus having the first identification information corresponding to the stored UI information.

In the content reception apparatus, the authenticating unit transmits the stored URL to the content transmission apparatus, the label of the exchange key obtained through the second authentication being added to the stored URL.

In the content reception apparatus, when a response to the transmission of the URL is received from the content transmission apparatus within a predetermined period of time, reproduction of the content recorded in the content recording unit is started.

In the content reception apparatus, when reproduction of the content recorded in the content recording unit is ended, the authenticating unit performs third authentication with the content transmission apparatus.

In the content reproduction apparatus, the information to be used in the reproduction process includes a pointer to the content recorded in the content recording unit. In the content reception apparatus, the content of the pointer is reproduced after the process including the second authentication is performed.

In the content reception apparatus, after the first authentication is performed, the content protected from copying is received from the content transmission apparatus in accordance with a move protocol.

The technique disclosed in this specification also relates to a content reception method that includes: performing first authentication with a content transmission apparatus; receiving content from the content transmission apparatus; recording the received content; performing a process including second authentication with the content transmission apparatus; and reproducing the recorded content.

The technique disclosed in this specification also relates to content transmission apparatus that includes: a communication unit that communicates with a content reception apparatus; an authenticating unit that performs mutual authentication and shares an exchange key with the content reception apparatus; a content providing unit that transmits the content encrypted with the exchange key from the communication unit to the content reception apparatus; and a managing unit that stores the exchange key and the label of the exchange key associated with identification information of the content reception apparatus, and stores a connection record including a lock flag indicating whether to discard the record of the exchange key and the label.

In the content transmission apparatus, the content providing unit transmits the content to the content reception apparatus after the authenticating unit performs first authentication with the content reception apparatus, and the lock flag in the corresponding connection record is set when the label of the exchange key shared with the content reception apparatus in the second authentication performed by the authenticating unit is received together with the URL of the content.

In the content transmission apparatus, the duration of the content corresponding to the received URL is set in the timer for the connection record, the timer is prompted to count down, and the managing unit resets the lock flag in the connection record when the value of the timer therein becomes zero.

In the content transmission apparatus, when the authenticating unit performs third authentication with the content reception apparatus, the managing unit resets the lock flag in the corresponding connection record.

In the content transmission apparatus, when a content transmission request including the label of the exchange key shared with the content reception apparatus in second authentication performed by the authenticating unit is received, the managing unit resets the lock flag in the corresponding connection record.

The technique disclosed in this specification also relates to a content transmission method that includes: performing first authentication with a content reception apparatus; performing second authentication with the content reception apparatus by transmitting content to the content reception apparatus; and setting a lock flag in the corresponding connection record when the label of the exchange key shared in the second authentication is received from the content reception apparatus.

### Advantageous Effects of Invention

According to the technique disclosed in this specification, it is possible to provide a preferred content reception apparatus and a preferred content reception method that can appropriately use received content under a predetermined limit.

The content reception apparatus to which the technique disclosed in this specification is applied can put a predetermined limit on the use of content by performing virtual streaming to reproduce content that has been downloaded beforehand. The content reception apparatus is not allowed to reproduce downloaded content unless remote authentication with the content transmitter is successfully performed. Accordingly, unlimited use of content can be prevented.

According to the technique disclosed in this specification, it is possible to provide a preferred content transmission apparatus and a preferred content transmission method that can put a predetermined limit on the use of transmitted content.

The content transmission apparatus to which the technique disclosed in this specification is applied can limit parallel streaming processes while content downloaded into the content transmission destination is being reproduced.

The advantageous effects described in this specification are merely examples, and the advantageous effects of the present technique are not limited to them. The present technique might achieve additional effects other than the above described advantageous effects.

Other objects, features, and advantages of the technique disclosed in this specification will be made apparent by the following detailed description based on the embodiments described below and the accompanying drawings.

### BRIEF DESCRIPTION OF DRAWINGS

FIG. 1 is a diagram schematically showing an example configuration of a content transmission system 100 to which the technique disclosed in this specification is applied;

FIG. 2 is a diagram schematically showing another example configuration of a content transmission system 200 to which the technique disclosed in this specification is applied;

FIG. 3 is a diagram schematically showing the functional structure of a content transmission apparatus 300 operating as the server 101 or 201 in FIG. 1 or 2;

FIG. 4 is a diagram schematically showing the functional structure of a content reception apparatus 400 operating as the terminal 102 or 202 in FIG. 1 or 2;

FIG. 5 is a diagram showing the procedures for registering a sink device that performs remote access with a source device;

FIG. 6 is a diagram schematically showing the procedures for performing content transmission through remote access between a source device and a sink device;

FIG. 7 is a diagram schematically showing the details of a content list viewing phase (SEQ601);

FIG. 8 is a diagram showing the details of an RA-AKE procedure phase (SEQ602);

FIG. 9 is a diagram showing the storing of an remote-access exchange key K_{R} and the exchange key label K_{R}_{_{—}}label that are generated as an RAC record for a sink device, and are associated with the sink ID;

FIG. 10 is a diagram schematically showing the details of a content transmission phase (SEQ603) for encryption and transmission with the use of the remote-access exchange key K_{R};

FIG. 11 is a flowchart showing the procedures for remotely downloading content for virtual streaming at the terminal 202;

FIG. 12 is a flowchart showing an example of the procedures for virtually streaming content that is downloaded at the terminal 202;

FIG. 13 is a flowchart showing another example of the procedures for virtually streaming content that is downloaded at the terminal 202;

FIG. 14 is a flowchart showing the procedures to be carried out by the server 201 to lock the RAC record of the terminal 202 performing virtual streaming;

FIG. 15 is a flowchart showing the procedures to be carried out by the server 201 to unlock the RAC record of the terminal 202 performing virtual streaming;

FIG. 16 is a flowchart showing the procedures to be carried out by the server 201 to unlock the RAC record of the terminal 202 that has suspended virtual streaming;

FIG. 17 is a flowchart showing the procedures to be carried out by the server 201 to unlock the RAC record of the terminal 202 when content transmission is performed through HTTP GET;

FIG. 18 is a diagram showing an example configuration of a personal computer 1800 that can operate as the server 201 or a source device of DTCP;

FIG. 19 is a diagram showing an example structure of a recorder 1900 that can operate as the server 201 or a source device of DTCP;

FIG. 20 is a diagram showing an example structure of a network access server (NAS) 2000 that can operate as the server 201 or a source device of DTCP; and

FIG. 21 is a diagram showing the configuration of a computer program distribution system 2100.

### DESCRIPTION OF EMBODIMENTS

The following is a detailed description of embodiments of the technique disclosed in this specification, with reference to the accompanying drawings.

A. System Configuration

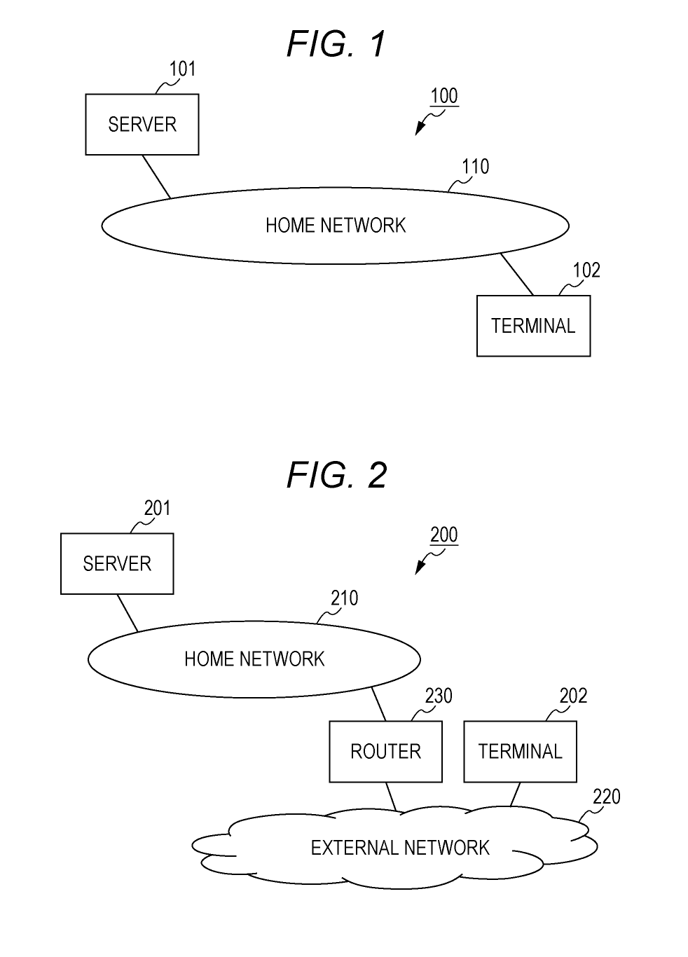

FIG. 1 schematically shows an example configuration of a content transmission system 100 to which the technique disclosed in this specification is applied. The content transmission system 100 shown in the drawing includes a server 101 and a terminal 102 that are placed in a home network 110 set in a household. Although the drawing shows only one server and only one terminal for simplicity, two or more servers and two or more terminals may be placed in the home network 110.

The server 101 is a device that provides content to the terminal 102. The server 101 may be a set-top box, a recorder, a television receiver, a personal computer, or a network access server (NAS), for example. The server 101 provides the terminal 102 with broadcast content received or recorded through digital terrestrial broadcasting, commercial content such as a movie read from a recording medium (not shown) such as a Blu-ray Disc, or content acquired from a content server (not shown) in the Internet. To provide content, streaming or content moving (MOVE) is performed, for example.

The terminal 102 is an apparatus that requests content from the server 101 over the home network 110, and is a multifunctional mobile terminal such as a portable telephone, a smartphone, or a tablet.

In this embodiment, different kinds of apparatuses, like the server 101 and the terminal 102, are connected to each other via the home network 110 in accordance with a protocol created by the DLNA, for example. The communication procedures to be carried out when the server 101 and the terminal 102 are connected to each other conform to UPnP (Universal Plug and Play), for example, and processes such as device discovery are performed.

Also, in this embodiment, when compressed content such as a movie or a recorded TV program is transmitted between the server 101 and the terminal 102 connected to each other, an encryption process compliant with DTCP, for example, is used so as to prohibit unauthorized use. Specifically, after the terminal 102 and the server 101 authenticate each other and share a key in accordance with a predetermined mutual authentication and key exchange (AKE) algorithm, the terminal 102 requests content stored in the server 101. Using the shared key, the server 101 encrypts and transmits the requested content. The server 101 providing content is equivalent to a source device according to DTCP, and the terminal 102 using the content is equivalent to a sink device according to DTCP. Where the server 101 is to be accessed (remotely accessed) by the terminal 102 from outside the home network 110 or from outside the home, there is a need to register beforehand the terminal 102 with the server 101 in the home network 110.

FIG. 2 schematically shows another example configuration of a content transmission system 200 to which the technique disclosed in this specification is applied. The content transmission system 200 shown in the drawing includes a server 201 that is placed in a home network 210 set in a household, and a terminal 202 that is connected to an external network 220 such as the Internet. The home network 210 and the external network 220 are connected to each other via a router 230 in accordance with an IP protocol. Although this drawing shows only one server and only one terminal for simplicity, two or more servers may be placed in the home network 210, or a terminal may be connected to the home network 210 while two or more terminals are connected to the external network 220.

The server 201 may be a set-top box, a recorder, a television receiver, a personal computer, a network access server (NAS), or the like. The server 201 provides broadcast content, commercial content, or the like to the terminal 202 that remotely accesses the server 201 from the external network 220. To provide content, streaming or content moving (MOVE) is performed, for example.

The terminal 202 is a multifunctional mobile terminal such as a portable telephone, a smartphone, or a tablet, and requests content from the server 201 over an IP network formed with the home network 210 and the external network 220.

In this embodiment, different kinds of apparatuses, like the server 201 and the terminal 202, are connected to each other via the home network 210 and the external network 220 in accordance with a protocol created by the DLNA, for example. The communication procedures to be carried out when the server 201 and the terminal 202 are connected to each other conform to UPnP, for example, and processes such as device discovery are performed.

Also, in this embodiment, when compressed content such as a movie or a recorded TV program is transmitted between the server 201 and the terminal 202 connected to each other, an encryption process compliant with DTCP, for example, is used so as to prohibit unauthorized use. Specifically, after the terminal 202 and the server 201 authenticate each other and share an exchange key over the IP network formed with the home network 210 and the external network 220, the terminal 202 requests content stored in the server 201. Using the shared exchange key, the server 201 encrypts and transmits the content requested by the terminal 202. There is a need to register the terminal 202 with the server 201 beforehand in the home network 210 (described later). The server 201 providing content is equivalent to a source device according to DTCP, and the terminal 202 using the content is equivalent to a sink device according to DTCP.

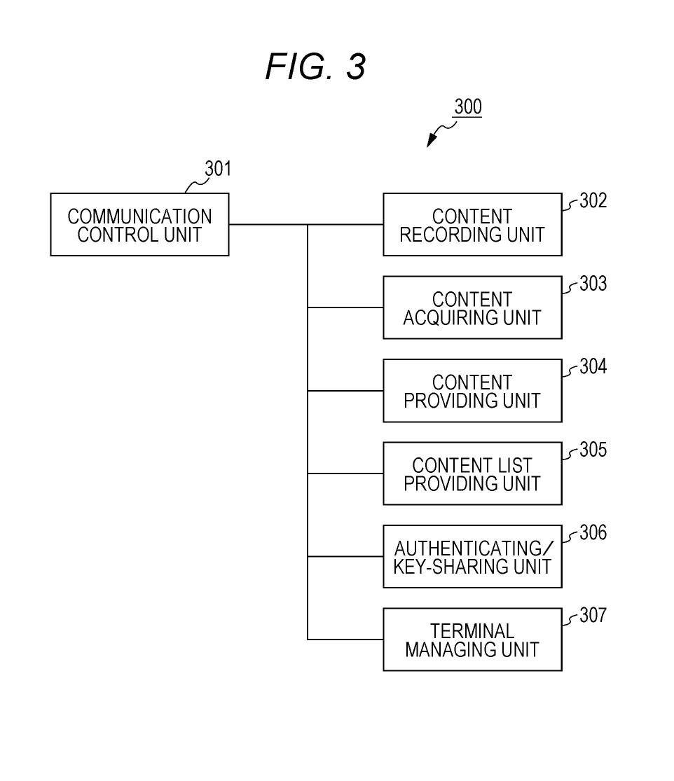

FIG. 3 schematically shows the functional structure of a content transmission apparatus 300 that operates as the server 101 or 201 (which is a source device) in FIG. 1 or 2. Specific examples of the servers 101 and 201 include set-top boxes, recorders, television receivers, personal computers, network access servers (NASs), and the like.

A communication control unit 301 controls communication operations being performed via a home network or an external network, and collectively controls operations of the entire content transmission apparatus 300. In this embodiment, the communication control unit 301 and a different kind of apparatus such as a terminal are connected to each other via the home network or the external network in accordance with a protocol created by the DLNA. The communication procedures to be carried out at a time of interconnection conform to UPnP, for example, and the communication control unit 301 performs processes such as device discovery.

The communication control unit 301 has an interface for connection (or digital content output) with an external device such as an HDMI (a registered trade name: High Definition Multimedia Interface), an MHL (a registered trade name: Mobile High-definition Link), or a USB (universal Serial Bus), and a recording/reproducing device such as a hard disk device or a Blu-ray Disc device can be externally connected to the communication control unit 301.

A content recording unit 302 is formed with a hard disk drive (HDD), a solid-state drive (SSD), or the like, and records content to be provided to the terminal 101 or 201 over the home network or the external network. As for each piece of the content recorded in the content recording unit 302, the recording date, the access date, and the duration are stored under the management of a general file system.

A content acquiring unit 303 acquires content to be provided to the terminal 101 or 201, and records the content in the content recording unit 302 as necessary. In some cases, the content acquiring unit 303 might acquire content to be provided to a terminal from the content recording unit 302.

The content acquiring unit 303 is formed with a digital terrestrial broadcasting tuner, for example, and acquires broadcast content. The content acquiring unit 303 in this case is based on a specification that is set by the ARIB (Association of Radio Industries and Businesses), for example. The content acquiring unit 303 has a function to receive all or some of the segments of broadcast channels, an EPG (Electronic Program Guide) function (for program searches, program information display, and program reservations), a copy control function compliant with the HDCP (High-bandwidth Digital Content Protection) specification or the like, and a content protection function to receive broadcast content in a restricted manner and encrypt received broadcast content to be output to the outside, for example.

In a case where the server 101 or 201 is a network access server, the content acquiring unit 303 does not receive broadcast waves, but acquires content recorded by a recorder or content to be reproduced by a media reproduction apparatus via a network, and records the content in the content recording unit 302 as necessary.

The content acquiring unit 303 may also be formed with a media reproduction apparatus such as a Blu-ray Disc device, and read commercial content such as a movie from a medium. Alternatively, the content acquiring unit 303 may be formed with a browser or the like, and download paid or free content from a content server (not shown) in the Internet.

A content providing unit 304 provides a terminal with content acquired by the content acquiring unit 303, in response to a request from the terminal. In a case where a terminal requests content through remote access from an external network, the terminal may need to be registered with a terminal managing unit 307 in advance. The content providing unit 304 compresses and transmits the content to the terminal, using HTTP (Hyper Text Transfer Protocol), for example. The content providing unit 304 has a compression function or includes a content compression processing unit not shown in FIG. 3. To provide content, content streaming or content moving (MOVE) is performed, for example.

The DTCP standards are applied in this embodiment so as to maintain security of content to be transmitted or prevent unauthorized use of content to be transmitted. Specifically, the content providing unit 304 encrypts compressed content by using the exchange key (described later) shared with the terminal by virtue of an authenticating/key-sharing unit 306, and then transmits the encrypted content to the terminal.

A content list providing unit 305 provides a terminal with a list of and detailed information about content that can be provided to terminals, in response to a request from the terminal, for example. As is apparent from the above description, examples of content that can be provided to terminals by the server 101 or 201 include broadcast content received by the content acquiring unit 303, commercial content read from a medium, and content already recorded in the content recording unit 302. To provide the content list, the CDS (Content Directory Service) function to hierarchize and distribute a content list and detailed information about content as specified in UPnP, on which the DLNA is based, is used.

The authenticating/key-sharing unit 306 and a terminal that requests content authenticate each other and share an exchange key for content encryption in accordance with the authentication and key exchange (AKE) algorithm that is set by DTCP+. The authenticating/key-sharing unit 306 shares a remote-access exchange key K_{R} (described later) with a terminal that requests content through remote access from an external network.

The terminal managing unit 307 manages information about terminals that request content. The terminal managing unit 307 registers beforehand each terminal that uses content through remote access from an external network, and stores information about the terminal in a “remote sink registry”. The terminal managing unit 307 also manages “RAC (Remote Access Connection) records” (described later) that are records of information about remotely authenticated (RA-AKE) terminals in a “RAC (Remote Access Connection) registry”.

The above described functional blocks 303 through 307 may be realized as an application program to be executed in a high order of an operating system or a TCP/IP protocol at the communication control unit 301. This kind of application program can be distributed by a predetermined download site in a wide area network such as the Internet, and is downloaded for use in a CE (Consumer Electronics) device such as a digital broadcasting tuner or television receiver, or a multifunctional terminal such as a recorder, a personal computer, a network access server (NAS), or a smartphone.

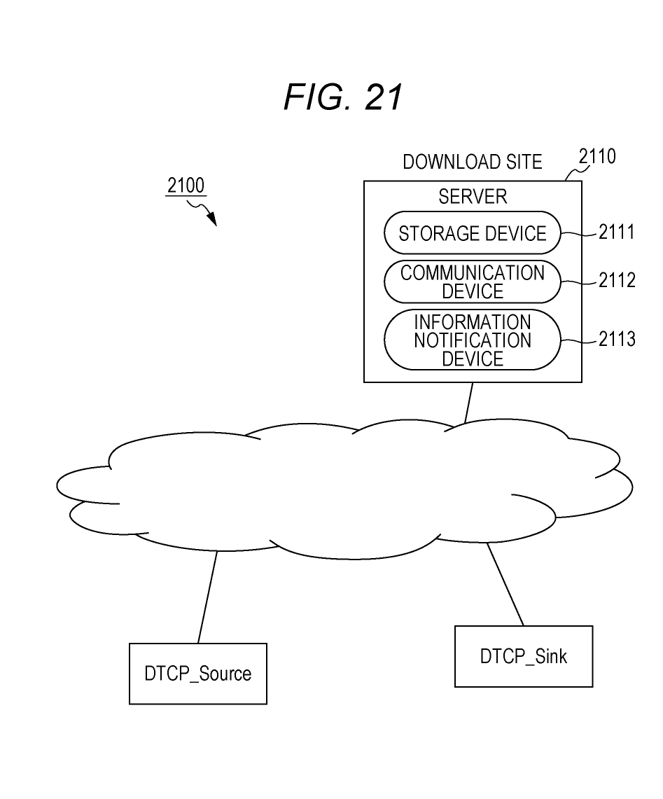

Such a download site is formed with a server 2110 that includes a storage device 2111 that stores computer programs, and a communication device 2112 that authorizes downloading in response to a request for downloading of a computer program (see FIG. 21). The server 2110 and a client device (a DTCP_Source or a DTCP_Sink) into which the downloaded computer program is installed constitute a computer program distribution system 2100. The server 2110 further includes an information notification device 2113 that notifies a client of information indicating the name of a computer program in response to a request for downloading of the computer program. The information notification device 2113 notifies the client not only of the name of the computer program but also of information indicating that the computer program is an application for providing a remote terminal with commercial content recorded for household use, for example.

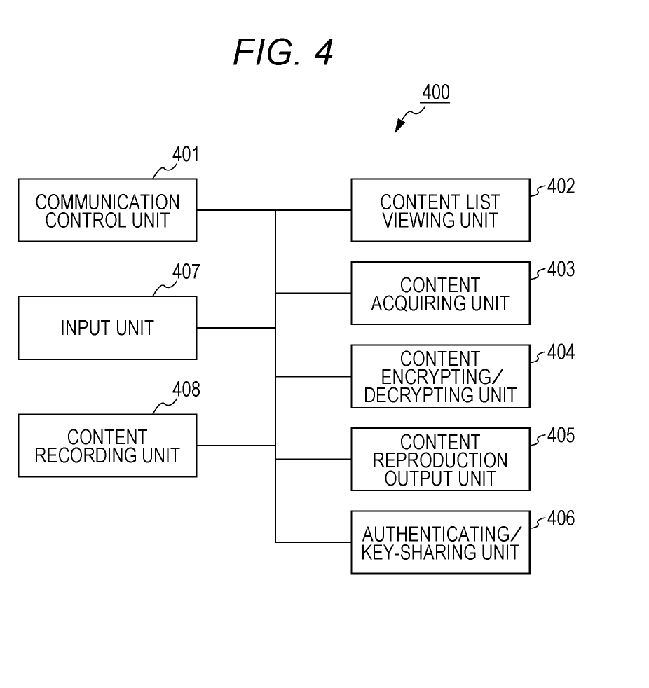

FIG. 4 schematically shows the functional structure of a content reception apparatus 400 that operates as the terminal 102 or 202 (which is a sink) in FIG. 1 or 2. Specific examples of the terminals 102 and 202 include multifunctional mobile terminals such as portable telephones, smartphones, and tablets.

A communication control unit 401 controls communication operations being performed via a home network or an external network, and collectively controls operations of the entire content reception apparatus 400. In this embodiment, the communication control unit 401 and a different kind of apparatus such as a server are connected to each other via the home network or the external network in accordance with a protocol created by the DLNA. The communication procedures to be carried out at a time of interconnection conform to UPnP, for example, and the communication control unit 301 performs processes such as device discovery.

A content list viewing unit 402 requests the server 101 or 201 serving as a source to acquire a content list, and displays a screen for viewing the acquired content list. For example, when a list of content that can be provided by the server 101 or 201 is acquired as CDS information (described above) specified in UPnP, on which the DLNA is based, a content list (CDS list) screen is displayed. A user can operate the content list screen with an input unit 407, to select content to be reproduced and output. In this embodiment, content for virtual streaming (described later) can also be selected from the content list screen.

A content acquiring unit 403 transmits a content acquisition request to the server 101 or 201, and acquires content in the server. The content acquiring unit 403 requests for acquisition of content selected by a user from the content list screen displayed by the content list viewing unit 402, for example. For example, HTTP is used (described later) to transmit the content acquisition request to the server 101 or 201 and acquire content. To acquire content, content streaming or content moving (MOVE) is performed, for example. Content in a compressed format is transmitted from the server 101 or 201.

The DTCP standards are applied in this embodiment so as to maintain security of content to be transmitted or prevent unauthorized use of content to be transmitted. Therefore, compressed content acquired by the content acquiring unit 403 from a server is encrypted by an authenticating/key-sharing unit 406 using the exchange key (described later) shared with the server. A content encrypting/decrypting unit 404 decrypts encrypted content acquired from the server 101 or 201 by using the encryption key, and further expands the compressed content. In this embodiment, the content encrypting/decrypting unit 404 also performs an encryption process when content downloaded for virtual streaming (described later) is recorded in a content recording unit 408.

The content recording unit 408 is formed with a hard disk drive (HDD), a solid-state drive (SSD), or the like, and records content acquired (downloaded) by the content acquiring unit 403 from the server 101 or 201. However, when content encrypted by the server 101 or 201 using the exchange key is decrypted by the content encrypting/decrypting unit 404, the content recording unit 408 again encrypts the content by using the key unique to the content reception apparatus, and records the content bound to the content reception apparatus. The content encryption and recording is specified in DTCP Adopter Agreement, EXHIBIT B Audiovisual, Part 1, 2.2.1.2.

A content reproduction output unit 405 reproduces and outputs content decrypted and expanded by the content encrypting/decrypting unit 404. The content reproduction output unit 405 includes a display unit that displays content such as a moving image. The content reproduction output unit 405 might also reproduce and output content that is temporarily recorded (downloaded) in the content recording unit 408.

If the content reception apparatus 400 is allowed unlimited downloading and reproduction, content in the home server can be permanently used. In this embodiment, when the content reproduction output unit 405 reproduces and outputs content downloaded into the content recording unit 408 (“virtual streaming”, which will be described later), a pseudo streaming request for is issued to the server through remote reauthentication or the like, to put a certain limit on downloading and reproduction. Virtual streaming will be described later in detail.

The authenticating/key-sharing unit 406 and the server 101 or 201 from which content is to be requested authenticate each other and share an encryption key for content encryption in accordance with the authentication and key exchange (AKE) algorithm that is set by DTCP-IP. The authenticating/key-sharing unit 406 shares a remote-access exchange key K_{R} with the server 201 from which content is to be requested through remote access from an external network. While connected to the home network 210, the authenticating/key-sharing unit 406 registers with the server 201 beforehand for remote access. In this embodiment, the authenticating/key-sharing unit 406 performs not only an authentication process when receiving content from the server 101 or 201, but also performs a remote authentication process on the server 201 for virtual streaming (described later). However, this aspect will be described later in detail.

The above described functional blocks 402 through 406 may be realized as an application program to be executed in a high order of an operating system or a TCP/IP protocol at the communication control unit 401. This kind of application program can be distributed from a predetermined download site in a wide area network such as the Internet, and is downloaded for use in a multifunctional terminal such as a smartphone that reproduces content in the home server.

Such a download site is formed with a server 2110 that includes a storage device 2111 that stores computer programs, and a communication device 2112 that authorizes downloading in response to a request for downloading of a computer program (see FIG. 21). The server 2110 and a client device (a DTCP_Source or a DTCP_Sink) into which the downloaded computer program is installed constitute a computer program distribution system 2100. The server 2110 further includes an information notification device 2113 that notifies a client of information indicating the name of a computer program in response to a request for downloading of the computer program. The information notification device 2113 notifies the client not only of the name of the computer program but also of information indicating that the computer program is an application for allowing viewing of commercial content recorded for household use at a remote place, for example.

In a possible utility form of the content transmission system 200 shown in FIG. 2, the terminal 202 such as a portable telephone device or a multifunctional mobile terminal may be connected to the server 201 in the house via the external network 220 and the router 230 from a remote place, and content (such as recorded broadcast content) recorded in the content recording unit 302 of the server 201 may be viewed. Such a utility form is advantageous for a user, because content can be viewed anywhere. However, this utility form is disadvantageous for a content provider, because content can be permanently viewed even at a remote place.

For example, from the viewpoint of a broadcasting organization, broadcast content is permanently viewed by residents outside the service area. As a result, the broadcasting business of the local station might be adversely affected, or content might be viewed in a place not covered by a content procurement contract.

To view content on the side of the terminal 202, streaming or downloading is used, for example. Streaming is advantageous for a user, because no waiting time is necessary to reproduce content. However, it is sometimes difficult to secure the communication band required for video transmission (when streaming is used while the user is moving around, for example). On the other hand, downloaded content is advantageous for a user, because such content can be reproduced offline, and reproduction quality can be guaranteed. From the viewpoint of a content provider, streaming is controllable, but it is difficult to control reproduction of content downloaded into the terminal 202, increasing the fear that the content might be permanently viewed as described above.

In view of this, in the technique disclosed in this specification, the terminal 202 puts a certain limit on content reproduction by allowing advance downloading of content data (see FIG. 10) but reproducing downloaded content through virtual streaming.

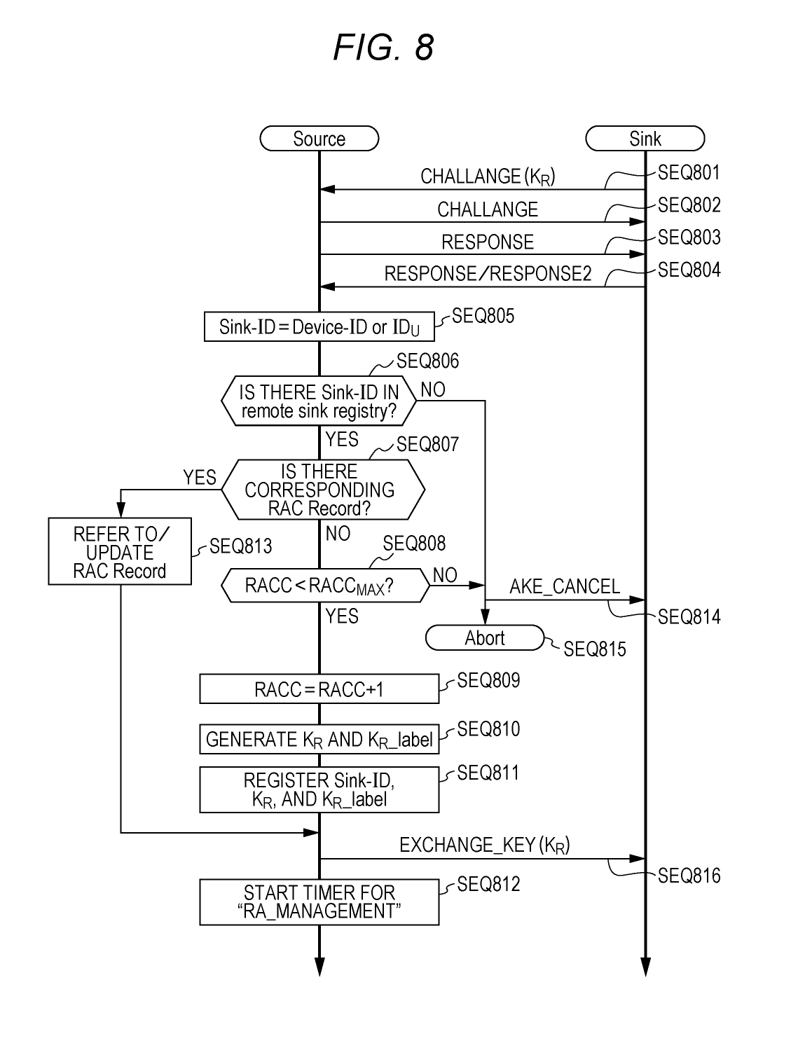

In virtual streaming, the terminal 202 behaves as if to perform streaming reproduction toward the server 201. Specifically, the terminal 202 performs remote authentication (see FIG. 8) with the server 201, from which the content to be reproduced is downloaded, and identifies the exchange key obtained through the remote authentication, to issue a pseudo request for streaming of the content. The terminal 202 does not reproduce the downloaded content if the remote authentication with the server 201 is not successful, and does not reproduce the downloaded content while holding the exchange key either. Accordingly, unlimited use of the downloaded content is not allowed.

In virtual streaming, the terminal 202 can use content that has been downloaded beforehand, instead of acquiring content data from the server 201 through communication. Accordingly, even when it is difficult to secure the communication band necessary for video transmission as the user is moving, the terminal 202 reproduces content that has been downloaded beforehand. Accordingly, reproduction quality can be maintained.

Meanwhile, the server 201 receives a request for virtual streaming from the terminal 202, and accordingly, can manage the virtual streaming being performed on the side of the terminal 202. While virtual streaming is being performed at the terminal 202, the server 201 can restrict parallel streaming processes.

As described above, according to the technique disclosed in this specification, stable content reproduction can be performed at the terminal 202 while unlimited reproduction of content downloaded into the terminal 202 is restricted. Also, when content is viewed on the terminal 202 in a remote environment or the like, random access can be performed at high speed, as there is no need to acquire content data through communication.

B. Registration Procedures

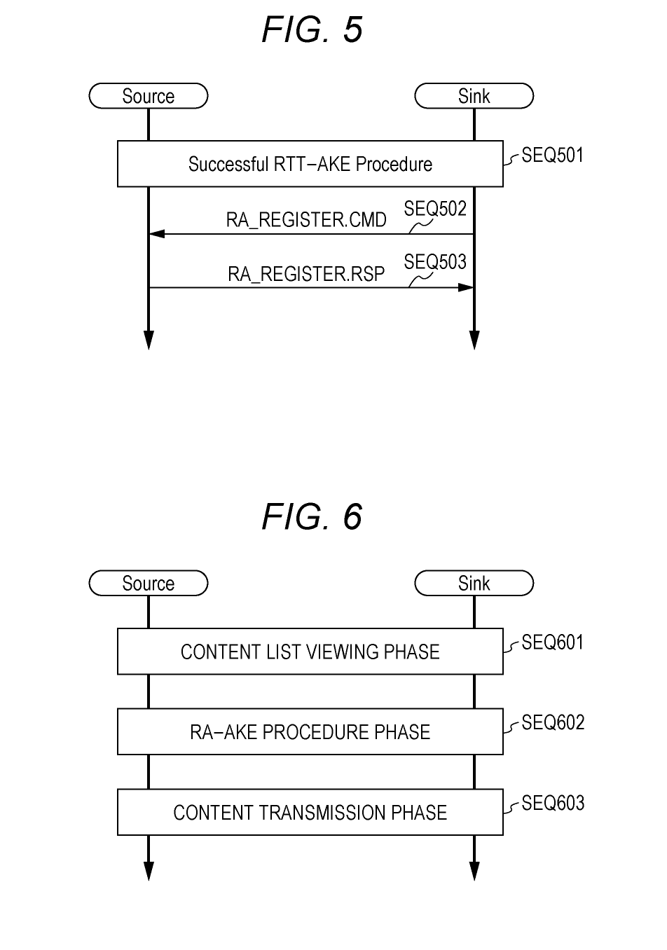

FIG. 5 shows the procedures for registering a sink device that performs remote access with a source device (a remote sink registration process). In this sequence chart, it should be understood that the sink device is equivalent to the terminal 202, and the source device is equivalent to the server 201. The registration procedures can be carried out only in the home network 210, and is not allowed to be performed from a remote place.

First, an AKE procedure is carried out between the source device and the sink device under the limit of an RTT and a TTL (SEQ 501). For example, if the source device and the sink device are inside the home network 210, the RTT and TTL limits are cleared, and the AKE procedure is successfully ended. The RTT-AKE procedure is not related directly to the scope of the technique disclosed in this specification, and therefore, detailed explanation of it will not be made herein.

After the RTT-AKE procedure is successfully ended, the sink device transmits its own sink ID to the source device, using a command RA_REGISTER.CMD (SEQ502).

Here, the sink device transmits a device ID or an IDu unique to its own device as the sink ID (the IDu is used as the sink ID in a case where the device ID does not serve as the information for identifying the sink device, since the sink device is provided with a common device key and a common device certificate).

Meanwhile, the source device determines whether the sink ID received through RA_REGISTER.CMD matches the device ID or IDu received through the just-completed RTT-AKE procedure and has not been stored in a remote sink registry, and whether the remote sink registry is not full. If all these conditions are satisfied, information about the sink device is registered in the remote sink registry. The source device notifies the sink device that the sink ID is added to the remote sink registry by returning RA_REGISTER.RSP to the sink device (SEQ503).

The above described registration procedures are carried out in accordance with a DTCP specification, such as Section V1SE.10.7.1 of DTCP Volume 1 Supplement E Mapping DTCP to IP, Revision 1.4ed1 (Informational Version).

C. Content Transmission Procedures

FIG. 6 schematically shows the procedures for performing content transmission through remote access between the source device and the sink device after the above described registration. In this sequence chart, it should be understood that the sink device is equivalent to the terminal 202, and the source device is equivalent to the server 201.

The content transmission shown in the chart is formed with a content list viewing phase (SEQ601) for designating content to be requested by the sink device, an RA-AKE procedure phase (SEQ602) for the source device and the sink device to share the remote-access exchange key K_{R} by performing mutual authentication and carrying out key exchange procedures, and a content transmission phase (SEQ603) for encrypting and transmitting the content designated in the content list viewing phase by using the remote-access exchange key K_{R}.

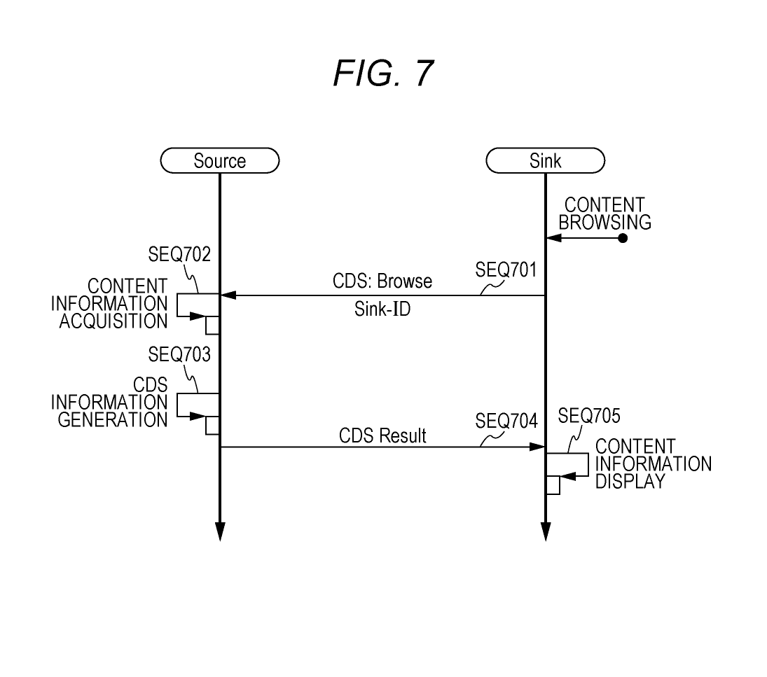

FIG. 7 schematically shows the details of the content list viewing phase (SEQ601). In this sequence chart, it should be understood that the sink device is equivalent to the terminal 202, and the source device is equivalent to the server 201.

The sink device issues a content list viewing request from the content list viewing unit 402 (SEQ701). To view a content list, the CDS function specified in UPnP on which DLNA is based can be used. In this case, a CDS browse action is issued from the sink device in SEQ701. The source device then hierarchizes and distributes the content list, which is the CDS list and the detailed information about content.

On the source device side, in response to the issuance of the CDS browse action, the content list providing unit 305 acquires all the acquirable content information about the content the content providing unit 304 can provide (SEQ702), and generates a sufficient amount of CDS information (SEQ703). The content the content providing unit 304 may be broadcast content or commercial content that can be acquired by the content acquiring unit 303, or content already recorded in the content recording unit 302, which is the storage of the device. The source device then returns a CDS result to the sink device (SEQ704).

On the sink device side, the content list viewing unit 402 analyzes the received CDS result, and displays content information that includes the content titles and more detailed information (SEQ705).

The user of the sink device operates the input unit 407, to select the content to be reproduced from the displayed content list (a CDS list of content directory services of UPnP). As the content is selected, the URL (Uniform Resource Locator) of the content and the UI (User Interface) information are acquired. The UI information includes information useful for content selection, such as the title of the content.

Based on the acquired URL, the sink device can request the content from the source device. However, mutual authentication and a key exchange for remote access, or an RA-AKE process, are performed between the sink device and the source device prior to content transmission.

FIG. 8 shows the details of the RA-AKE procedure phase (SEQ602). In this sequence chart, it should be understood that the sink device is equivalent to the terminal 202, and the source device is equivalent to the server 201. The procedures shown in the chart are based on the particulars in Section V1SE.10.7.2 of the DTCP specification (described above).

The sink device transmits a CHALLENGE command that includes an exchange key field in which the bit for the remote-access exchange key K_{R} (the remote exchange key) is set, and requests an AKE process from the source device (SEQ801). The challenge response portion in the authentication procedure is then executed between the source device and the sink device (SEQ802 through SEQ804).

If the bit for K_{R} is not set in the CHALLENGE command, however, the source device can abort the RA-AKE procedure, and carry out an AKE procedure other than RA-AKE.

Through the challenge response procedure, the source device can receive the device ID or the IDu as the sink ID from the sink device (SEQ805).

The source device then determines whether the received sink ID is registered in the remote sink registry being managed in the terminal managing unit 307 of its own, or whether the sink device has been registered beforehand (SEQ806).

If the sink device has not been registered yet, or if the corresponding sink ID is not listed in the remote sink registry (No in SEQ806), the source device transmits an AKE_CANCEL command to the sink device (SEQ814), and aborts the RA-AKE procedure (SEQ815).

If the sink device has already been registered, or if the corresponding sink ID exists in the remote sink registry (Yes in SEQ806), on the other hand, the source device checks the inside of the RAC registry to determine whether the remote-access exchange key K_{R} is shared with the sink device, or whether the RAC record (described later) corresponding to this sink ID already exists in the RAC registry (SEQ807).

If the RAC record corresponding to the sink ID exists (Yes in SEQ807), the source device determines to use the remote-access exchange key K_{R} and the exchange key label K_{R}_{_{—}}label stored in the RAC record. Alternatively, if content transmission has not been performed with the use of the remote-access exchange key K_{R}, the source device may refer to the RAC record, and update the values of the stored K_{R} and K_{R}_{_{—}}label (SEQ813). In this embodiment, a lock flag is provided in the RAC record (as will be described later) so as to restrict parallel streaming processes of the source device. If the lock flag is set, however, the lock flag is reset when the RAC record is updated (SEQ813).

In a case where the remote-access exchange key K_{R} is not shared, and the corresponding RAC record does not exist, though the sink ID has already been registered in the remote sink registry (No in SEQ807), the source device determines whether the count value RACC for counting RAC records is smaller than RACC_{maX} (SEQ808). Here, RACCₘₐₓ is a counter that counts remote access connections, and is initialized to be zero when there are no remote access connections.

If RACC is not smaller than RACC_{maX} (No in SEQ808), the source device transmits an AKE_CANCEL command to the sink device (SEQ814), and aborts the RA-AKE procedure (SEQ815).

If RACC is smaller than RACCₘₐₓ (Yes in SEQ808), the source device increments the value of RACC by 1 (SEQ809), then generates the remote-access exchange key K_{R} and the exchange key label K_{R}_{_{—}}label in accordance with a predetermined algorithm (SEQ810), and stores the key and the label associated with the sink ID of the sink device into the RAC record in the RAC registry (SEQ811). At this point, the lock flag in the RAC record is in a reset state.

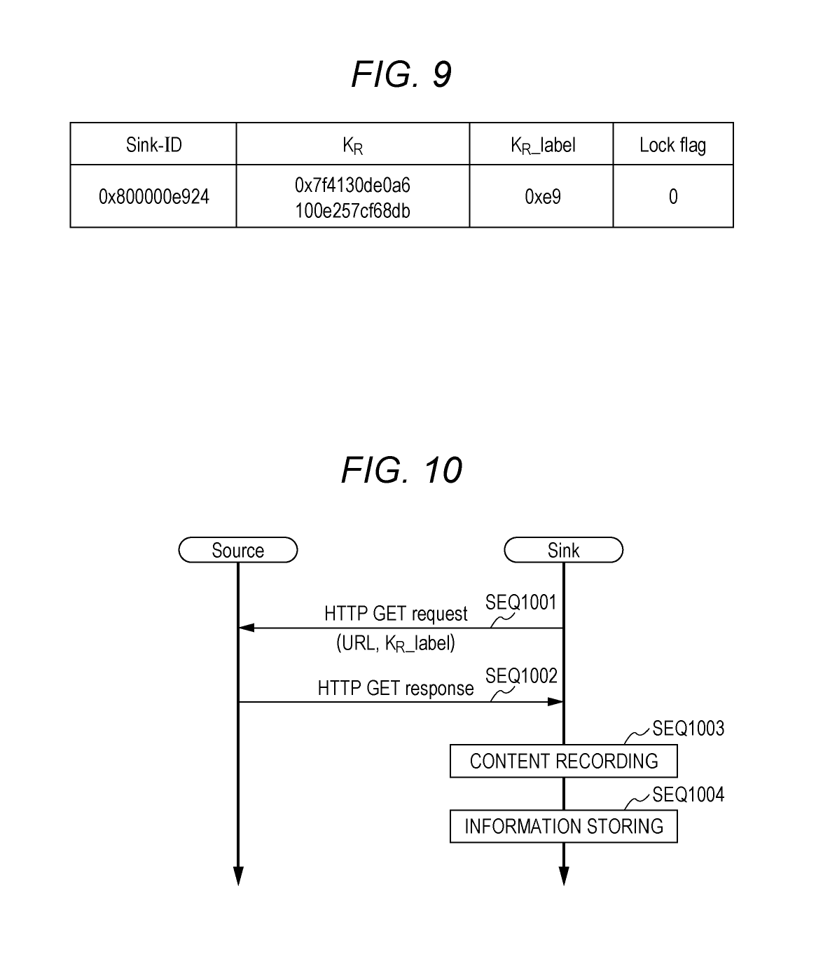

FIG. 9 shows the storing of the remote-access exchange key K_{R} and the exchange key label K_{R}_{_{—}}label that are generated as an RAC record for the sink device and are associated with the sink ID. In the example shown in the drawing, the remote-access exchange key “0x7f4130de0a6100e257cf68 db” and the exchange key label “0xe9” are allocated to the sink device having the sink ID 0x800000e924. The RAC record shown in the drawing is formed by expanding an RAC record according to the DTCP specification and adding a lock flag to the expanded RAC record. The source device determines that a sink device with an RAC record having a lock flag set therein is using virtual streaming. In the example shown in the drawing, the lock flag is in a reset state.

The source device transmits the remote-access exchange key K_{R} and the exchange key label K_{R}_{_{—}}label extracted from the existing RAC record (which may be updated), or the remote-access exchange key K_{R} and exchange key label K_{R}_{_{—}}label that are newly generated, to the sink device (SEQ816).

In a case where the source device supports a RA_MANAGEMENT function, a K_{R} alive timer for maintaining the remote-access exchange key K_{R} is started, and K_{R} is maintained at least for one minute (SEQ812).

An RAC record in which the K_{R} alive timer has timed out is discarded from the RAC registry. The sink device can transmit a RA_MANAGEMENT command to the source device, so that its own RAC record will not be discarded.

FIG. 10 schematically shows the details of the content transmission phase (SEQ603) for encryption and transmission with the use of the remote-access exchange key K_{R}. In this sequence chart, it should be understood that the sink device is equivalent to the terminal 202, and the source device is equivalent to the server 201. In a case where the terminal 202 performs virtual streaming of content, this content transmission phase is equivalent to the process to download content data in advance.

After acquiring the remote-access exchange key K_{R} and the exchange key label K_{R}_{_{—}}label through the RA-AKE procedure, the sink device requests content transmission from the source device through an HTTP request using the HTTP GET method (HTTP GET request) (SEQ1001). To issue this request, the URL of the content selected in the content list viewing phase (SEQ601) and the label K_{R}_{_{—}}label as the ID of the remote-access exchange key K_{R} are sent. Here, the header field for sending the ID (K_{R}_{_{—}}label) of the exchange key from the sink device to the source device is defined.

When sending the remote-access exchange key K_{R} and the exchange key label K_{R}_{_{—}}label to the sink device in the RA-AKE procedure, the source device associates the key and the label with the sink ID, and stores the key and the label associated with the sink ID as an RAC record (as described above with reference to FIG. 9) into the RAC registry. Accordingly, the source device can obtain the sink ID of the sink device as the requester from the RAC record corresponding to the exchange key label K_{R}_{_{—}}label included in the content request.

To allow the content request from the sink device, the source device extracts the remote-access exchange key K_{R} designated by the exchange key label K_{R}_{_{—}}label from the RAC record, encrypts the content designated by the URL included in the HTTP request by using the encryption key generated from the exchange key K_{R}, and transmits the encrypted content as an HTTP response (HTTP GET response) to the sink device (SEQ1002).

In a case where content transmission does not involve streaming but does involve downloading for virtual streaming, the sink device re-encrypts the content downloaded from the source device, and records the re-encrypted content in the content recording unit 408 (SEQ1003). The sink device manages content to be recorded in the content recording unit 408 so that downloaded content will not be reproduced other than for virtual streaming. For example, content that is downloaded by performing remote authentication (RA-AKE) through an IP address and a TCP port prepared for DTCP remote access by the source device is encrypted and stored by the sink device using a secret key unique to the sink device. The encryption and recording is specified in DTCP Adopter Agreement, EXHIBIT B Audiovisual, Part 1, 2.2.1.2.

The sink device also stores information to be used when virtual streaming is performed (SEQ1004). Here, the information includes identification information defined by UPnP of the source device (Universal Unique ID: UUID), identification information defined by DTCP (Device ID), the URL and the UI information of the requested content, and pointer information to encrypted content in the content recording unit 408. The URL and the UI information of the content are both included in the CDS list of the content directory services of UPnP.

In a case where content for virtual streaming is remotely downloaded, the user preferably operate the terminal 202 as the download destination in an environment where high-speed communication can be performed, such as a Wi-Fi (Wireless-Fidelity: a registered trade name) hot spot.

D. Virtual Streaming

According to the technique disclosed in this specification, the terminal 202 puts a certain limit on content reproduction by allowing advance downloading of content data but reproducing downloaded content through virtual streaming.

In virtual streaming, the terminal 202 behaves as if to perform streaming reproduction toward the server 201. Specifically, the terminal 202 performs remote authentication with the server 201, from which the content to be reproduced is downloaded, and indicates the exchange key obtained through the remote authentication, to issue a pseudo request for streaming of the content. The terminal 202 does not reproduce the downloaded content unless the remote authentication with the server 201 is successful and the terminal 202 holds the exchange key obtained as a result of the successful remote authentication. Accordingly, unlimited use of the downloaded content is not allowed. From the viewpoint of the content provider, the fear that content downloaded from the terminal 202 is unlimitedly used can be reduced.

In virtual streaming, the terminal 202 uses content that has been downloaded beforehand, instead of acquiring content data from the server 201 through communication. Accordingly, even when it is difficult to secure the communication band necessary for video transmission as the user is moving, the terminal 202 reproduces content that has been downloaded beforehand. Accordingly, reproduction quality can be maintained.

Meanwhile, the server 201 receives a request for virtual streaming from the terminal 202, and accordingly, manages the virtual streaming being performed on the side of the terminal 202. Thus, the server 201 can restrict parallel streaming processes while virtual streaming is being performed at the terminal 202. From the viewpoint of the content provider, the fear that content downloaded through remote access is unlimited used can be reduced.

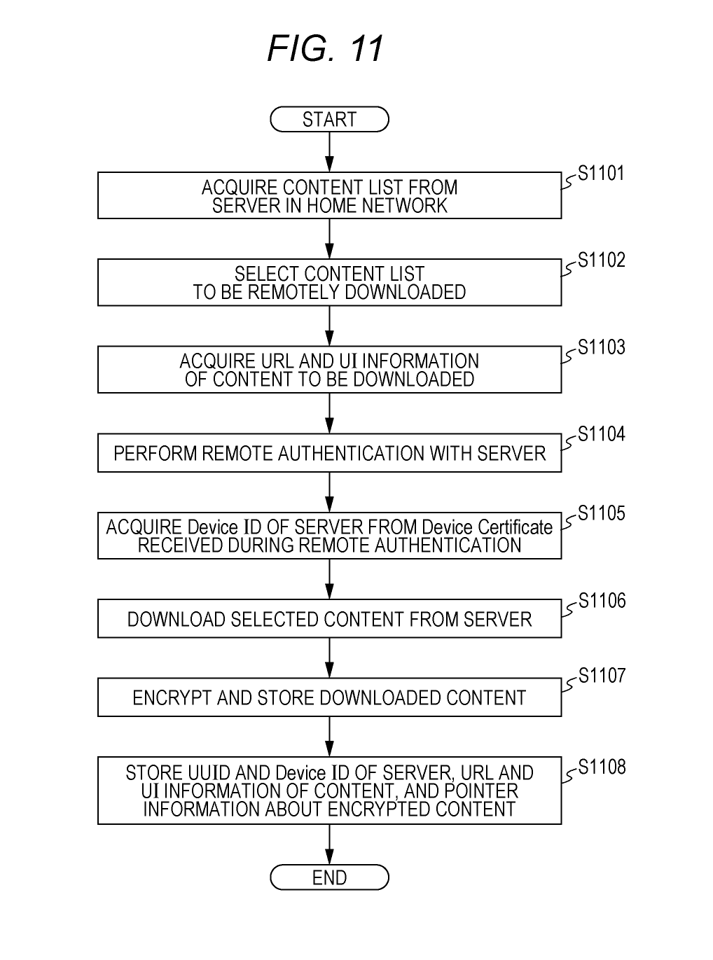

FIG. 11 is a flowchart showing the procedures for remotely downloading content for virtual streaming at the terminal 202. It should be understood that the terminal 202 is equivalent to the sink device, performs remote authentication with the server 201 serving as the source device, and acquires content.

First, the terminal 202 acquires the content list from the server 201 in the home network 210 (step S1101). When the user of the terminal 202 operates the input unit 407 to select content to be remotely downloaded (step S1102), the terminal 202 acquires, from the content list, the URL and the UI information of the content to be downloaded (step S1103). The UI information includes information useful for content selection, such as the title of the content.

Steps S1101 through S1103 are equivalent to the content list viewing phase (SEQ601).

The terminal 202 then performs remote authentication (RA-AKE) with the server 201 from which the content selected in step S1102 is to be downloaded (step S1104), and shares the remote-access exchange key K_{R} with the server 201. The remote authentication is equivalent to the RA-AKE procedure phase (SEQ602), and is basically carried out in accordance with the sequence shown in FIG. 8. The terminal 202 then acquires the device ID of the server 201 from the device certificate received from the server 201 through the challenge response procedure during the remote authentication (step S1105).

The terminal 202 then downloads the content selected in step S1102 from the server 201 by using the remote-access exchange key K_{R} (step S1106). If the copy control information about the content indicates copying prohibition (No-more-copy) at the time of downloading, the content is transmitted in accordance with the protected move protocol of DTCP-IP.

The terminal 202 then encrypts the downloaded content, and records the encrypted content in the content recording unit 408 (step S1107). Here, the terminal 202 controls the downloaded content not to be reproduced other than for virtual streaming (“not being reproduced other than for virtual streaming” means that reproduction is not allowed outside the period during which the exchange key shared through the remote authentication (RA-AKE) (described later) performed at the time of virtual streaming is held). For example, content that is downloaded by performing remote authentication (RA-AKE) through an IP address and a TCP port prepared for DTCP remote access by the source device is encrypted by the sink device using a secret key unique to the sink device, and is recorded in the content recording unit 408. The content encryption and recording is specified in DTCP Adopter Agreement, EXHIBIT B Audiovisual, Part 1, 2.2.1.2.

The terminal 202 as the sink device also stores the information to be used for performing virtual streaming into a virtual streaming content table (step S1108).

The information to be stored into the virtual streaming content table includes identification information defined by UPnP of the source device (Universal Unique ID: UUID), identification information defined by DTCP (Device ID), the URL and the UI information of the requested content, and pointer information to encrypted content in the content recording unit 408. The URL and the UI information of the content are both included in the CDS list of the content directory services of UPnP. In the terminal 202, the records in which the above described information is described for the respective pieces of content downloaded for virtual streaming are stored into a virtual streaming table.

Steps S1106 through S1108 are equivalent to the content transmission phase (SEQ603).

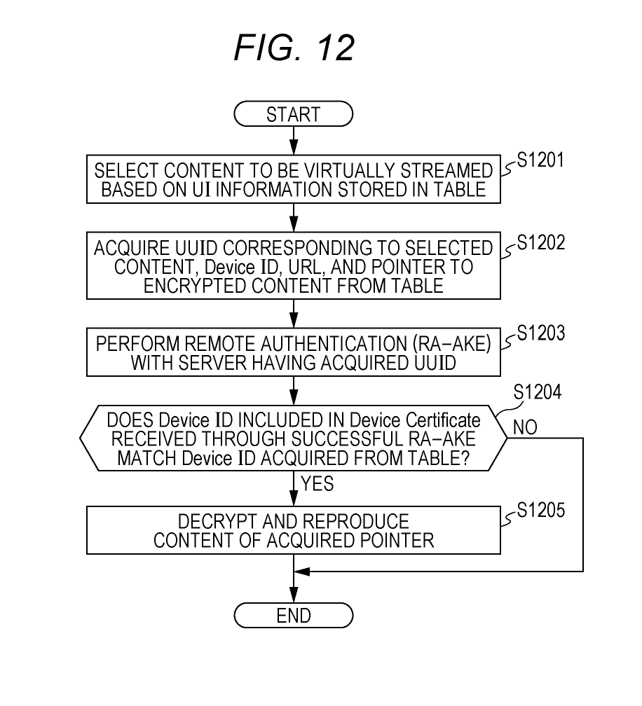

FIG. 12 is a flowchart showing an example of the procedures for virtually streaming content that is downloaded at the terminal 202. It should be understood that the terminal 202 is equivalent to the sink device, performs remote authentication (RA-AKE) with the server 201 serving as the source device, and performs virtual streaming.

The user of the terminal 202 selects content to be virtually streamed based on the UI information stored in the virtual streaming content table (step S1201). For example, the UI information of all the content stored in the virtual streaming content table is displayed in a list, and the user operates the input unit 407 to select content from the list screen.

The terminal 202 acquires, from the virtual streaming content table, the UUID corresponding to the content selected in step S1201, the device ID, the URL of the content, and the pointer to the encrypted content (step S1202).

The terminal 202 then performs remote authentication (RA-AKE) (see FIG. 8) with the server 201 having the acquired UUID (step S1203). In the procedures shown in FIG. 12, the terminal 202 performing the remote authentication with the server 201 triggers virtual streaming from the server 201.

If the remote authentication with the server 201 is successful, and the device ID included in the device certificate of the server 201 received through the remote authentication is the same as the device ID stored in the virtual streaming content table (Yes in step S1204), the terminal 202 causes the content encrypting/decrypting unit 404 to decrypt the encrypted content of the pointer acquired in step S1201, and causes the content reproduction output unit 405 to reproduce or virtually stream the decrypted content (step S1205).

If the remote authentication with the server 201 is not successful, or if the remote authentication is successful but the device ID acquired from the server 201 is not the same as any device ID stored in the virtual streaming content table (No in step S1204), on the other hand, the terminal 202 does not perform virtual streaming, and ends this processing routine.

In the procedures shown in FIG. 12, only successful remote authentication (RA-AKE) is the requirement for the terminal 202 to perform virtual streaming. Although the server 201 holds the RAC record (see FIG. 9) including the sink ID of the terminal 202 that has succeeded in remote authentication, the terminal 202 is not concerned with the holding period of the RAC record.

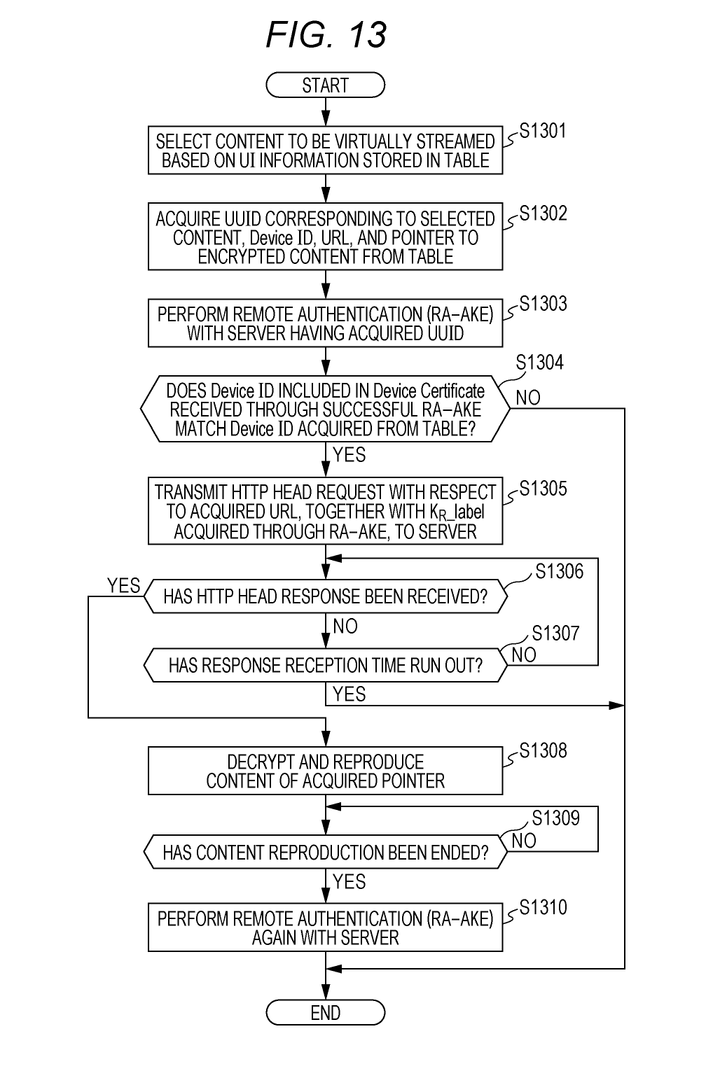

FIG. 13 is a flowchart showing another example of the procedures for virtually streaming content that is downloaded at the terminal 202. It should be understood that the terminal 202 is equivalent to the sink device, performs remote authentication with the server 201 serving as the source device, and performs virtual streaming.

The user of the terminal 202 selects content to be virtually streamed based on the UI information stored in the virtual streaming content table (step S1301). For example, the UI information of all the content stored in the virtual streaming content table is displayed in a list, and the user operates the input unit 407 to select content from the list screen.

The terminal 202 acquires, from the virtual streaming content table, the UUID corresponding to the content selected in step S1301, the device ID, the URL of the content, and the pointer to the encrypted content (step S1302).

The terminal 202 then performs remote authentication (RA-AKE) (see FIG. 8) with the server 201 having the acquired UUID (step S1303).

If the remote authentication with the server 201 is not successful, and the device ID included in the device certificate of the server 201 received through the unsuccessful remote authentication is not the same as the device ID stored in the virtual streaming content table (No in step S1304), the terminal 202 skips all the procedures that follow, and ends this processing routine.

If the remote authentication with the server 201 is successful, and the device ID received from the server 201 through the successful remote authentication is the same as the device ID stored in the virtual streaming content table (Yes in step S1304), the terminal 202 transmits an HTTP HEAD request with respect to the URL acquired in step S1302, together with the exchange key label K_{R}_{_{—}}label obtained through the remote authentication, to the server 201 (step S1305).

The HTTP HEAD request transmitted from the terminal 202 to the server 201 is a pseudo content streaming request to the server 201 (however, unlike an HTTP request, the HTTP HEAD request does not involve transmission of content data from the server 201). For example, the RemoteAccess.dtcp.com header field of the HTTP HEAD request is sent, or the LockRAC.dtcp.com header field is sent (in either case, the exchange key label K_{R}_{_{—}}label is also sent). LockRAC.dtcp.com is newly introduced to instruct the server 201 to set the lock flag (described above) in the RAC record.

Upon receipt of an HTTP HEAD response from the server 201 (Yes in step S1306), the terminal 202 causes the content encrypting/decrypting unit 404 to decrypt the encrypted content of the pointer acquired in step S1301, and causes the content reproduction output unit 405 to reproduce or virtually stream the decrypted content (step S1308).

In the procedures shown in FIG. 13, the terminal 202 transmitting an HTTP HEAD request as a pseudo streaming request to the server 201, as well as performing remote authentication with the server 201, triggers virtual streaming from the server 201.

After ending the content reproduction (Yes in step S1309), the terminal 202 again performs remote authentication (RA-AKE) with the server 201 (step S1310). When the content reproduction is ended in step S1309, the entire content has been reproduced, or the reproduction of the content has been stopped by a user operation or the like.

Every time performing remote authentication, the server 201 updates the RAC record (see SEQ813 in FIG. 8). Therefore, in the procedures shown in FIG. 13, the terminal 202 is concerned with the holding period of the RAC record in the server 201, unlike the case of the procedures shown in FIG. 12. Since the server 201 resets the lock flag when updating the RAC record, the limit on parallel streaming processes is lifted (described later).

If there is no HTTP HEAD response from the server 201 (No in step S1306) before the response reception time runs out (No in step S1307), the terminal 202 does not perform virtual streaming, skips all the procedures that follow, and ends this processing routine. When the RAC record including the exchange key label K_{R}_{_{—}}label in the HTTP HEAD request does not exist, the server 201 does not return an HTTP HEAD response. Accordingly, the server 201 can certainly limit the number of parallel authentication processes in steps S1306 and S1307, and limit parallel streaming processes.

In the procedures shown in FIG. 13, the requirements for the terminal 202 to perform virtual streaming include not only successful remote authentication (RA-AKE), but also issuing a pseudo streaming request (or transmitting an HTTP HEAD request) to the server 201, and the pseudo streaming request being received (or receiving an HTTP HEAD response). While the server 201 holds the RAC record (see FIG. 9) including the sink ID of the terminal 202 that has succeeded in remote authentication, the terminal 202 is concerned with the holding period of the RAC record.

E. Limit on Parallel Streaming Processes

So as to reduce the content provider's fear that content is unlimitedly used at more than one terminals, the server 201 needs to limit streaming to other terminals while the terminal 202 is performing virtual streaming, or limit parallel streaming processes.

In a case where regular streaming is performed, the server 201 holds the RAC record including the sink ID of the terminal 202 that has performed remote authentication (RA-AKE), during the transmission of content to the terminal 202. Accordingly, two or more streaming processes are not started at the same time.

In the case of virtual streaming, however, the server 201 does not transmit content to the terminal 202 as described above, and therefore, might discard the RAC record generated during the remote authentication (RA-AKE) with the terminal 202. In that case, the server 201 can start another streaming process by performing new remote authentication (RA-AKE) while the terminal 202 is performing virtual streaming, and therefore, the limit on parallel streaming processes is relaxed.

According to an example method of preventing relaxation of the limit on parallel streaming processes, the terminal 202 that is performing virtual streaming regularly transmits an RA_MANAGEMENT command to the server 201, so that the RAC record of the terminal 202 will not be discarded. Where this method is used, the terminal 202 does not need to transmit an HTTP HEAD request to the server 201 as in the procedures shown in FIG. 13. In other words, this method can be used in the procedures shown in FIG. 12. In this case, the terminal 202 performs virtual streaming only while its own RAC record is maintained in a response to the RA_MANAGEMENT command.

According to another example method of preventing relaxation of the limit on parallel streaming processes, the terminal 202 transmits an HTTP HEAD request to the server 201 when starting virtual streaming as in the procedures shown in FIG. 13. In this case, the server 201 does not discard the RAC record during the duration (the time required for reproduction) of the content corresponding the requested URL. For example, the server 201 sets the lock flag in the RAC record, so as not to discard the RAC record. When setting the lock flag in the RAC record, the server 201 also sets the duration of the content in the timer associated with the RAC record, and prompts the timer to start counting down. When the timer reaches zero, the server 201 resets the lock flag in the RAC record, and allows discarding of the RAC record.

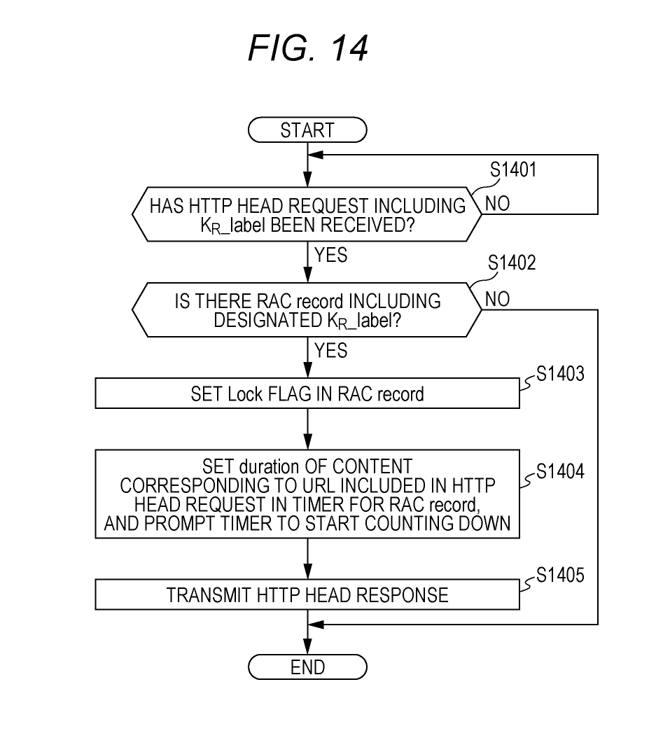

FIG. 14 is a flowchart showing the procedures to be carried out by the server 201 to lock the RAC record of the terminal 202 performing virtual streaming. It should be understood that the server 201 is equivalent to the source device, and receives an HTTP HEAD request from the terminal 202 serving as the sink device.

Upon receipt of an HTTP HEAD request including the exchange key label K_{R}_{_{—}}label (Yes in step S1401), the server 201 determines whether the RAC record including the designated label K_{R}_{_{—}}label is being managed in the authenticating/key-sharing unit 306 (step S1402).

If the RAC record including the designated label K_{R}_{_{—}}label is found (Yes in step S1402), the server 201 sets the lock flag in the RAC record (step S1403).

In this embodiment, the RAC record is formed by expanding an RAC record according to the DTCP specification and adding the lock flag to the RAC record (see FIG. 9). The server 201 determines that the terminal 202 with its RAC record having the lock flag set therein is using virtual streaming.

After setting the lock flag, the server 201 also sets the duration of the content corresponding to the URL included in the HTTP HEAD request received in step S1401 in the timer for the RAC record, and prompts the timer to start counting down (step S1404).

The server 201 then transmits an HTTP HEAD response to the terminal 202 as the requester (step S1405).

If the RAC record including the designated label K_{R}_{_{—}}label is not found (No in step S1402), the server 201 skips all the procedures that follow, and ends this processing routine.

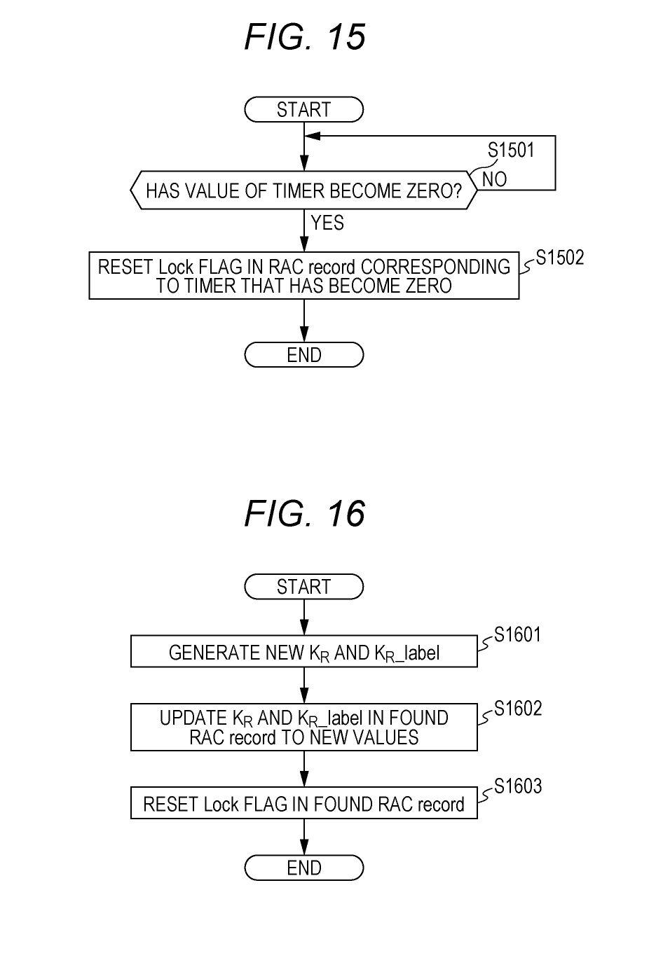

FIG. 15 is a flowchart showing the procedures to be carried out by the server 201 to unlock the RAC record of the terminal 202 performing virtual streaming. The process shown in FIG. 15 starts as a timer interrupt process, for example.

When the value of the timer that has been set when the lock flag in the RAC record was set becomes zero (Yes in step S1501), the server 201 can determine that the duration of the content being virtually streamed at the terminal 202 has run out, or the reproduction of the content has been ended. The server 201 then resets the lock flag in the RAC record corresponding to the timer (step S1502). Accordingly, this RAC record can be discarded, and a new RAC record based on remote authentication from another terminal can be generated.

As shown in FIG. 15, in a case where the lock flag in the RAC record is reset by causing the timer corresponding to the duration of the content being virtually streamed to count down, the lock flag continues to be set even if virtual streaming or reproduction of content is suspended on the side of the terminal 202. Since this case is equal to a case where streaming has already been ended, the server 201 is preferably able to discard the RAC record.

To solve this problem, the server 201 resets the lock flag in the corresponding RAC record when reproduction of content is suspended on the side of the terminal 202. Specifically, the terminal 202 performs remote authentication (RA-AKE) with the server 201 when reproduction of content is suspended. In the procedures for virtual streaming shown in FIG. 13, when content reproduction is suspended (Yes in step S1309), the terminal 202 again performs remote authentication (RA-AKE) with the server 201 (step S1310). Meanwhile, every time performing remote authentication (RA-AKE) with the terminal 202 having a valid RAC record, the server 201 always updates the exchange key K_{R} to forbid virtual streaming with the exchange key K_{R} prior to updating, and thus, resets the lock flag.

FIG. 16 is a flowchart showing the procedures to be carried out by the server 201 to unlock the RAC record of the terminal 202 that has suspended virtual streaming. It should be understood that the server 201 is equivalent to the source device, and performs remote authentication (RA-AKE) again when the terminal 202 equivalent to the sink device suspends virtual streaming. The RAC record is unlocked in the RAC record update procedure (SEQ813) in the RA-AKE procedure sequence shown in FIG. 8, for example.

After finding the RAC record corresponding to the sink ID of the terminal 202 (equivalent to SEQ806 and SEQ807), the server 201 generates the remote-access exchange key K_{R} and the exchange key label K_{R}_{_{—}}label for the terminal 202 (step S1601) (equivalent to SEQ810). The server 201 then updates the exchange key K_{R} and the exchange key label K_{R}_{_{—}}label in the found RAC record to new values (step S1602), and resets the lock flag (step S1603).

Even if the terminal 202 does not perform virtual streaming, there is always a possibility that an HTTP HEAD request will be transmitted to the server 201. An HTTP HEAD request is not a message for virtual streaming. Therefore, when transmitting content through HTTP GET, the server 201 may reset the lock flag that has been set through the procedures shown in FIG. 14.

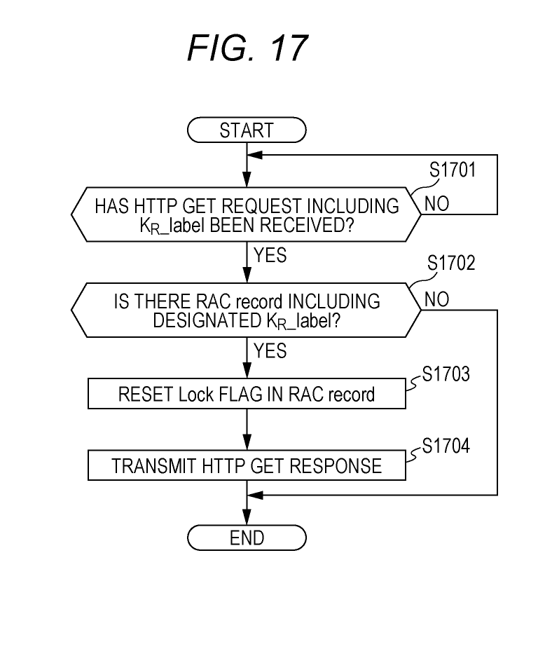

FIG. 17 is a flowchart showing the procedures to be carried out by the server 201 to unlock the RAC record of the terminal 202 when content transmission is performed through HTTP GET. It should be understood that the server 201 is equivalent to the source device, and receives an HTTP GET request for streaming from the terminal 202 equivalent to the sink device.

Upon receipt of an HTTP GET request including the exchange key label K_{R}_{_{—}}label (Yes in step S1701), the server 201 determines whether the RAC record including the designated label K_{R}_{_{—}}label is being managed in the authenticating/key-sharing unit 306 (step S1702).

If the RAC record including the designated label K_{R}_{_{—}}label is found (Yes in step S1702), the server 201 resets the lock flag in the RAC record (step S1703), and transmits an HTTP GET response to the terminal 202 (step S1704).

F. Specific Examples of Content Transmission Apparatuses

Specific examples of content transmission apparatuses that operate as the server 201 or source devices of DTCP include set-top boxes, recorders, television receivers, personal computers, network access servers (NASs), and the like.

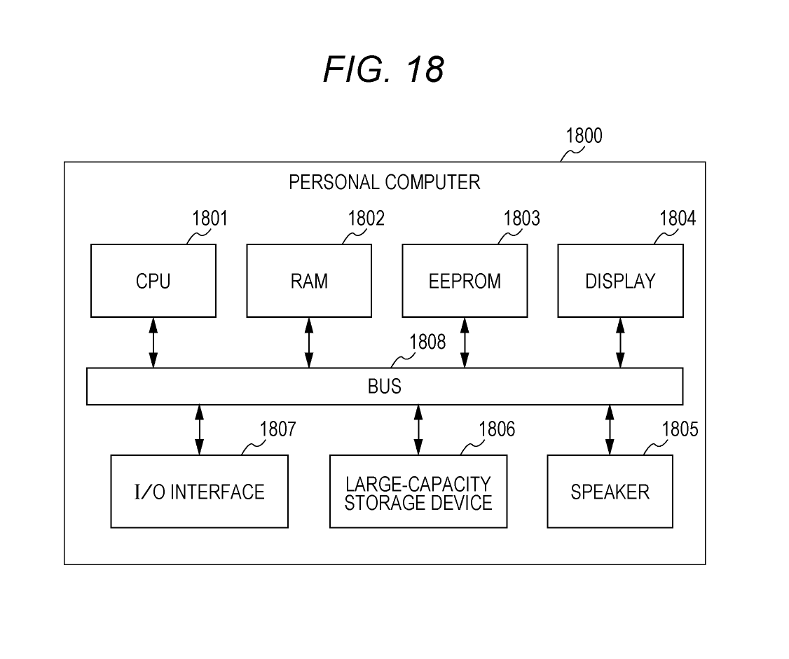

FIG. 18 shows an example configuration of a personal computer 1800 that can operate as the server 201 or a source device of DTCP. It should be understood that the personal computer 1800 is compatible with the remote access function (described above). The personal computer 1800 shown in the drawing is formed with circuit components including a CPU (Central Processing Unit) 1801, a RAM (Random Access Memory) 1802, an EEPROM (Electrically Erasable and Programmable ROM) 1803, a display 1804, a speaker 1805, a large-capacity information storage device 1806 such as an HDD (Hard Disc Drive) or an SDD (Super Density Disc), and an input/output interface 1807, and those circuit components are connected to one another via a bus 1808.

The CPU 1801 reads and executes a program downloaded into the RAM 1802 serving as the main memory.

The functions related to content encryption and decryption are loaded into the RAM 1802. For example, a program for executing the DTCP+ function and a program for executing the RA-AKE process are loaded into the RAM 1802.

The EEPROM 1803 is a rewritable nonvolatile memory device, and stores setting information and the like. In a case where the personal computer 1800 operates as the source device or a content transmission apparatus, the RAC record including the sink ID of the sink device is stored into the EEPROM 1803.

In the personal computer 1800, upon receipt of a request to register the sink device as a terminal that is allowed remote access, the CPU 1801 reads the program in which the DTCP+AKE process is written from the RAM 1802, and carries out the AKE procedure with the sink device. After successfully carrying out the procedure, the CPU 1801 generates the exchange key K_{R} and the label K_{R}_{_{—}}label in accordance with a program stored in the RAM 1802, and stores the key and the label as the RAC record associated with the sink ID into the EEPROM 1803.

If a request for the RA-AKE process is received after that in the personal computer 1800, the CPU 1801 compares the sink ID of the sink device making this request with the sink ID stored in the EEPROM 1803, and determines whether to complete the RA-AKE process.

When the RA-AKE process is completed, the exchange key to be shared between the personal computer 1800 and the sink device that has requested for the RA-AKE process is generated. On the side of the personal computer 1800, the content key generated based on the exchange key is temporarily stored, and, when content is read from the large-capacity information storage device 1806, the content is encrypted with the temporarily stored content key. The encrypted content is output to the outside through the input/output interface 1807. In a case where the input/output interface 1807 has a wireless LAN function, the encrypted content is transmitted to the sink device that has requested for the RA-AKE process via a wireless LAN.

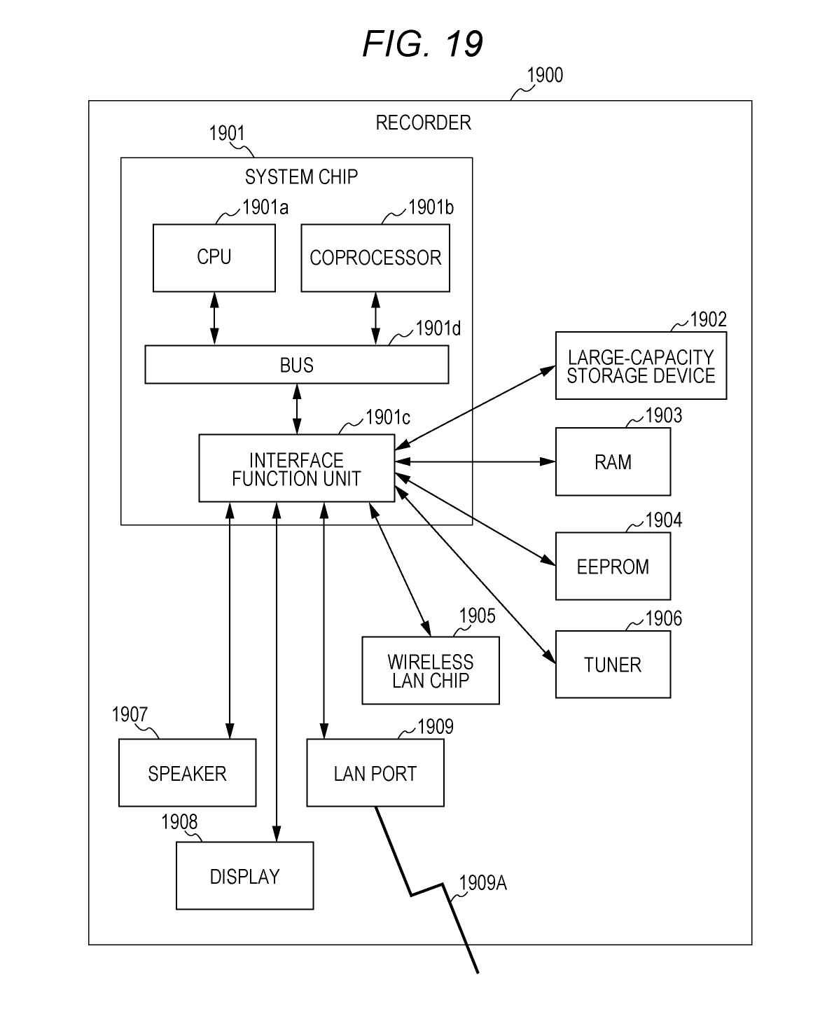

FIG. 19 shows an example structure of a recorder 1900 that can operate as the server 201 or a source device of DTCP. It should be understood that the recorder 1900 is compatible with the remote access function (described above). The recorder 1900 shown in the drawing includes a system chip 1901, a large-capacity storage device 1902, a RAM 1903, an EEPROM 1904, a wireless LAN chip 1905 and/or a LAN port 1909, a tuner 1906, a speaker 1907, and a display 1908.

The system chip 1901 is formed with circuit modules including a CPU 1901a, a coprocessor 1901b, and an interface function unit 1901c, and these circuit modules are connected to one another by a bus 1901d in the chip.

The CPU 1901a can execute a program stored in a storage device connected thereto via the interface function unit 1901c.

The coprocessor 1901b is an auxiliary arithmetic device, and mainly compress or decode moving images. For example, the coprocessor 1901b executes an algorithm of H264, VC1, MPEG2, JPEG, or the like. When moving image content (stored in the large-capacity storage device 1902) is transmitted to a content reception apparatus such as a sink device, the coprocessor 1901b performs a process of converting the image size in accordance with the communication environment such as the communication speed so that the image can be transmitted in the optimum size in the communication environment, or performs codec transcoding. By virtue of the codec transcoding, the reproduction delay at the content transmission destination such as a sink device can be reduced. The codec transcoding may be performed not by special-purpose hardware such as the coprocessor 1901b, but by the CPU 1901a. The compression rate at which the transcoding of content is performed may be designated by a user for each piece of content.

The large-capacity storage device 1902 may be an HDD or an SDD, for example, and stores content to be provided to a sink device or a content reception apparatus.

The tuner 1906 selects and receives broadcast signals of digital terrestrial broadcasting or the like. In this embodiment, television programs are recorded or recording is programmed in accordance with a function such as the EPG (Electronic Program Guide), and broadcast content is stored into the large-capacity storage device 1902.

Broadcast programs received by the tuner 1906 and content stored in the large-capacity storage device 1902 can be viewed by using the speaker 1907 and the display 1908.

The wireless LAN chip 1905 performs processes in a physical layer and a MAC (Media Access Control) layer compliant with wireless LAN standards such as Wi-Fi (Wireless Fidelity) or IEEE802.11, and is wirelessly connected to the content reception apparatus serving as the sink device via a predetermined access point or in a direct manner. The LAN port 1909 is connected to a cable LAN (not shown) such as the Ethernet (a registered trade name) via an inserted LAN cable 1909A, and performs processes in a physical layer and a MAC layer compliant with cable LAN standards such as IEEE802.3, to communicate with the content reception apparatus serving as the sink device.

The programs to be executed by the CPU 1901a are loaded into the RAM 1903 serving as the main memory. Typical programs to be loaded into the RAM 1903 are programs for realizing functions related to content encryption and decryption. For example, a program for executing the DTCP+ function and a program for performing the RA-AKE process are loaded into the RAM 1903.

The EEPROM 1904 is a rewritable nonvolatile memory device, and stores setting information and the like. In a case where the recorder 1900 operates as the source device or a content transmission apparatus, the RAC record including the sink ID of the sink device is stored into the EEPROM 1904.

In the recorder 1900, upon receipt of a request to register the sink device as a terminal that is allowed remote access, the CPU 1901a reads the program in which the DTCP-IP AKE process is written from the RAM 1903, and carries out the AKE procedure with the sink device. After successfully carrying out the procedure, the CPU 1901a generates the exchange key K_{R} and the label K_{R}_{_{—}}label in accordance with a program stored in the RAM 1903, and stores the key and the label as the RAC record associated with the sink ID into the EEPROM 1904.

If a request for the RA-AKE process is received after that in the recorder 1900, the CPU 1901a compares the sink ID of the sink device making this request with the sink ID of the sink device stored in the EEPROM 1904, and determines whether to complete the RA-AKE process.

When the RA-AKE process is completed, the content key to be shared between the recorder 1900 and the sink device that has requested for the RA-AKE process is generated. On the side of the recorder 1900, the generated content key is temporarily stored, and, when content is read from the large-capacity storage device 1902, the content is encrypted with the temporarily stored content key. The encrypted content is transmitted to the terminal that has requested for the RA-AKE process, via the interface function unit 1901c and the wireless LAN chip 1905.

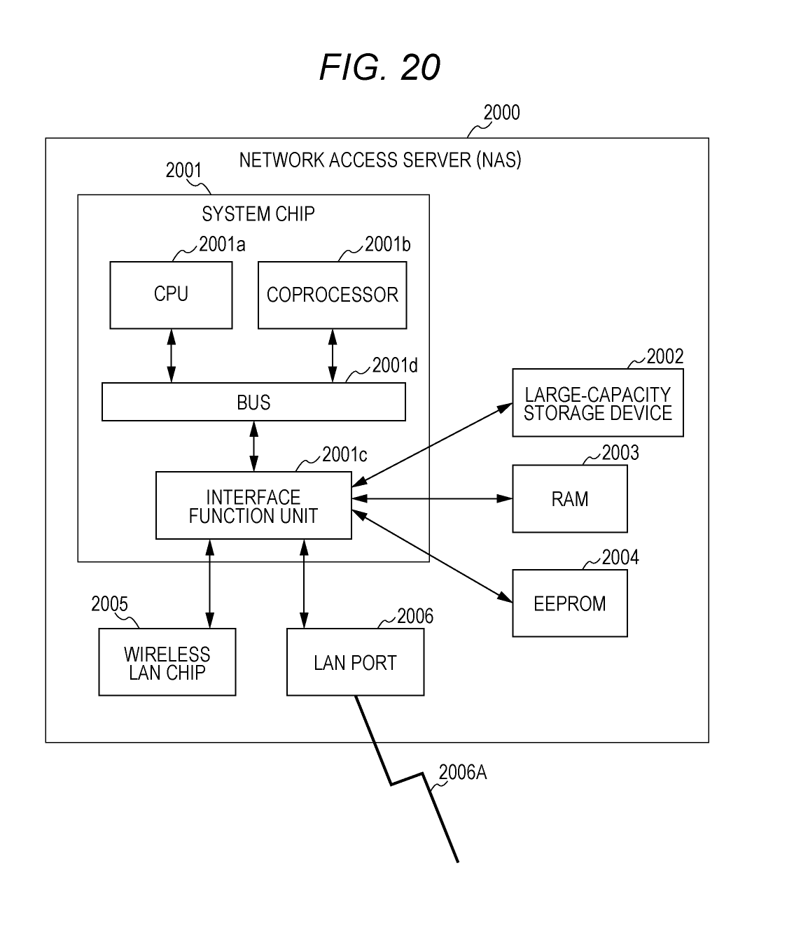

FIG. 20 shows an example structure of a network access server (NAS) 2000 that can operate as the server 201 or a source device of DTCP.

The network access server 2000 includes a large-capacity storage device, is placed in the home network 110 or 210, and transmits information stored in the large-capacity storage device in accordance with an IP protocol. For example, broadcast content recorded in the recorder 1900 can be copied and stored into the network access server 2000, and content stored in the network access server 2000 can be transmitted to a sink device such as the personal computer 1800 or a smartphone for viewing. It should be understood that the network access server 2000 is also compatible with the remote access function.

The network access server 2000 shown in the drawing includes a system chip 2001, a large-capacity storage device 2002, a RAM 2003, an EEPROM 2004, and a wireless LAN chip 2005 and/or a LAN port 2006.

The system chip 2001 is formed with circuit modules including a CPU 2001a, a coprocessor 2001b, and an interface function unit 2001c, and these circuit modules are connected to one another by a bus 2001d in the chip.

The CPU 2001a can execute a program stored in a storage device connected thereto via the interface function unit 2001c.

The coprocessor 2001b is an auxiliary arithmetic device, and mainly compress or decode moving images. For example, the coprocessor 2001b executes an algorithm of H264, VC1, MPEG2, JPEG, or the like. When moving image content (stored in the large-capacity storage device 2002) is transmitted to a content reception apparatus such as a sink device, the coprocessor 2001b performs a process of converting the image size in accordance with the communication environment such as the communication speed so that the image can be transmitted in the optimum size in the communication environment, or performs codec transcoding. By virtue of the codec transcoding, the reproduction delay at the content transmission destination such as a sink device can be reduced. The codec transcoding may be performed not by special-purpose hardware such as the coprocessor 2001b, but by the CPU 2001a. The compression rate at which the transcoding of content is performed may be designated by a user for each piece of content.

The large-capacity storage device 2002 may be an HDD or an SDD, for example, and stores content to be provided to a sink device or a content reception apparatus. For example, broadcast content recorded in the recorder 1900 can be copied and stored into the large-capacity storage device 2002 (after received via the wireless LAN chip 2005).

The wireless LAN chip 2005 performs processes in a physical layer and a MAC (Media Access Control) layer compliant with wireless LAN standards such as Wi-Fi (Wireless Fidelity) or IEEE802.11, and is wirelessly connected to the content reception apparatus serving as the sink device via a predetermined access point or in a direct manner. The LAN port 2006 is connected to a cable LAN (not shown) such as the Ethernet (a registered trade name) via an inserted LAN cable 2006A, and performs processes in a physical layer and a MAC layer compliant with cable LAN standards such as IEEE802.3, to communicate with the content reception apparatus serving as the sink device.

The programs to be executed by the CPU 2001a are loaded into the RAM 2003 serving as the main memory. Typical programs to be loaded into the RAM 2003 are programs for realizing functions related to content encryption and decryption. For example, a program for executing the DTCP-IP function and a program for performing the RA-AKE process are loaded into the RAM 2003.

The EEPROM 2004 is a rewritable nonvolatile memory device, and stores setting information and the like. In a case where the network access server 2000 operates as the source device or a content transmission apparatus, the RAC record including the sink ID of the sink device is stored into the EEPROM 2004.

In the network access server 2000, upon receipt of a request to register the sink device as a terminal that is allowed remote access, the CPU 2001a reads the program in which the DTCP+ AKE process is written from the RAM 2003, and carries out the AKE procedure with the sink device. After successfully carrying out the procedure, the CPU 2001a allocates the exchange key K_{R} and the label K_{R}_{_{—}}label to the sink ID in accordance with a program stored in the RAM 2003, and stores the key and the label associated with the sink ID into the EEPROM 2004.

If a request for the RA-AKE process is received after that in the network access server 2000, the CPU 2001a compares the sink ID of the sink device making this request with the sink ID of the sink device stored in the EEPROM 2004, and determines whether to complete the RA-AKE process.

When the RA-AKE process is ended, the content key to be shared between the network access server 2000 and the sink device that has requested for the RA-AKE process is generated. On the side of the network access server 2000, the generated content key is temporarily stored, and, when content is read from the large-capacity storage device 2002, the content is encrypted with the temporarily stored content key. The encrypted content is transmitted to the terminal that has requested for the RA-AKE process, via the interface function unit 2001c and the wireless LAN chip 2005.

### INDUSTRIAL APPLICABILITY

The technique disclosed in this specification has been described in detail, with reference to particular embodiments. However, it is obvious that a person skilled in the art can make modifications to and substitutions of the embodiments without departing from the scope of the technique disclosed in this specification.

Although embodiments applying the technique disclosed in this specification to networks compliant with the DTCP and DTCP specifications have been described above, the subject matter of the technique disclosed in this specification is not limited to them. The technique disclosed in this specification can also be applied to various communication systems that put limits on remote access to content in a home network, other than systems compliant with DTCP+.

Furthermore, the scope of the technique disclosed in this specification is not limited to remote access to a home network. Where reproduction of content downloaded into a terminal is also to be limited at a time of local access within a home network, the technique disclosed in this specification can be used.

To sum up, the technique disclosed in this specification has been described through examples, and the descriptions in this specification are not to be interpreted in a restrictive manner. The claims should be taken into account in understanding the subject matter of the technique disclosed in this specification.

The technique disclosed in this specification can also be embodied in the structures described below.

(1) A content reception apparatus including:
a communication unit that communicates with a content transmission apparatus;
an authenticating unit that performs mutual authentication with the content transmission apparatus;
a content recording unit that records content; and
a content reproduction output unit that reproduces the content, wherein
the content is received from the content transmission apparatus and is recorded in the content recording unit after the authenticating unit performs first authentication with the content transmission apparatus, and the content recorded in the content recording unit is reproduced after the authenticating unit performs a process including second authentication with the content transmission apparatus.
(2) The content reception apparatus of (1), wherein
the communication unit communicates with the content transmission apparatus in accordance with communication procedures compliant with DLNA (digital Living Network Alliance) or UPnP (Universal Plug and Play), the authenticating unit performs the mutual authentication and shares an exchange key with the content transmission apparatus in accordance with the authentication and key exchange (AKE) algorithm set by DTCP (Digital Transmission Content Protection), and content encryption and transmission is performed with the content transmission apparatus using the exchange key.
(3) The content reception apparatus of (1), wherein the content recorded in the content recording unit is controlled not to be reproduced when the exchange key obtained through the process including the second authentication is not held.
(4) The content reception apparatus of (3), wherein the content is encrypted with a secret key unique to the content reception apparatus and is recorded in the content recording unit.
(5) The content reception apparatus of (1), wherein, when the content is received from the content transmission apparatus as a result of the first authentication performed by the authenticating unit, information to be used in a reproduction process after the process including the second authentication is performed is stored.
(6) The content reception apparatus of (5), wherein first identification information of the content transmission apparatus is stored as the information to be used in the reproduction process, and
the authenticating unit performs the process including the second authentication with the content transmission apparatus having the stored first identification information.
(7) The content reception apparatus of (5), wherein second identification information included in a device certificate received from the content transmission apparatus in the first authentication is stored as the information to be used in the reproduction process, and the authenticating unit determines whether identification information included in a device certificate received from the content transmission apparatus in the second authentication is the same as the stored identification information.
(8) The content reception apparatus of (6), further including
a content information acquiring unit that acquires content information including the URL of content and UI information useful for content selection, wherein the URL of the content and the UI information are stored as the information to be used in the reproduction process.
(9) The content reception apparatus of (8), wherein the authenticating unit performs the process including the second authentication with the content transmission apparatus having the first identification information corresponding to the stored UI information.
(10) The content reception apparatus of (8), wherein the authenticating unit transmits an HTTP HEAD request with respect to the stored URL to the content transmission apparatus, an exchange key label obtained through the second authentication being added to the HTTP HEAD request.
(10-1) The content reception apparatus of (10), wherein the authenticating unit transmits the exchange key label attached to the URL to the content transmission apparatus through the HTTP HEAD request.
(10-2) The content reception apparatus of (10-1), wherein the authenticating unit transmits the HTTP HEAD request having one of a RemoteAccess.dtcp.com header field and a LockRAC.dtcp.com header field attached thereto.
(11) The content reception apparatus of (10), wherein, when a response to the transmission of the URL is received from the content transmission apparatus within a predetermined period of time, reproduction of the content recorded in the content recording unit is started.
(11-1) The content reception apparatus of (11), wherein the response is received as an HTTP HEAD response.
(12) The content reception apparatus of (1), wherein, when reproduction of the content recorded in the content recording unit is ended, the authenticating unit performs third authentication with the content transmission apparatus.
(13) The content reception apparatus of (5), wherein the information to be used in the reproduction process includes a pointer to the content recorded in the content recording unit, and
the content of the pointer is reproduced after the process including the second authentication is performed.
(14) The content reception apparatus of (1), wherein, after the first authentication is performed, the content protected from copying is received from the content transmission apparatus in accordance with a move protocol.
(15) A content reception method including:
performing first authentication with a content transmission apparatus;
receiving content from the content transmission apparatus;
recording the received content;
performing a process including second authentication with the content transmission apparatus; and
reproducing the recorded content.
(16) A content transmission apparatus including:
a communication unit that communicates with a content reception apparatus;
an authenticating unit that performs mutual authentication and shares an exchange key with the content reception apparatus;
a content providing unit that transmits the content encrypted with the exchange key from the communication unit to the content reception apparatus; and
a managing unit that stores the exchange key and the label of the exchange key associated with identification information of the content reception apparatus, and stores a connection record including a lock flag indicating whether to discard the record of the exchange key and the label.
(17) The content transmission apparatus of (16), wherein the communication unit communicates with the content reception apparatus in accordance with communication procedures compliant with DLNA or UPnP, and
the authenticating unit performs mutual authentication and shares the exchange key with the content reception apparatus in accordance with the authentication and key exchange (AKE) algorithm specified by DTCP.
(18) The content transmission apparatus of (16), wherein the content providing unit transmits the content to the content reception apparatus after the authenticating unit performs first authentication with the content reception apparatus, and
the lock flag in the corresponding connection record is set when the label of the exchange key shared with the content reception apparatus in the second authentication performed by the authenticating unit is received together with the URL of the content.
(18-1) The content transmission apparatus of (18), wherein the URL of the content and the label of the exchange key are received as an HTTP HEAD request.
(19) The content transmission apparatus of (18), wherein the duration of the content corresponding to the received URL is set in the timer for the connection record, the timer is prompted to count down, and
the managing unit resets the lock flag in the connection record when the value of the timer therein becomes zero.
(20) The content transmission apparatus of (18), wherein, when the authenticating unit performs third authentication with the content reception apparatus, the managing unit resets the lock flag in the corresponding connection record.
(21) The content transmission apparatus of (16), wherein, when a content transmission request including the label of the exchange key shared when the authenticating unit performs second authentication with the content reception apparatus is received, the managing unit resets the lock flag in the corresponding connection record.
(21-1) The content transmission apparatus of (21), wherein the content transmission request including the label of the exchange key is received in the form of an HTTP GET request.
(22) A content transmission method including: performing first authentication with a content reception apparatus;
performing second authentication with the content reception apparatus by transmitting content to the content reception apparatus; and
setting a lock flag in the corresponding connection record when an HTTP HEAD request including the label of the exchange key shared in the second authentication is received from the content reception apparatus.
(22-1) The content transmission method of (22), wherein the label of the exchange key is received in the form of an HTTP HEAD request from the content reception apparatus.

### REFERENCE SIGNS LIST

100 Content transmission system
101 Server
102 Terminal
110 Home network
201 Server
202 Terminal
200 Content transmission system
201 Server
202 Terminal
210 Home network
220 External network
230 Router
300 Content transmission apparatus (Source device)
301 Communication control unit
302 Content recording unit
303 Content acquiring unit
304 Content providing unit
305 Content list providing unit
306 Authenticating/key-sharing unit
307 Terminal managing unit
400 Content reception apparatus
401 Communication control unit
402 Content list viewing unit
403 Content acquiring unit
404 Content encrypting/decrypting unit
405 Content reproduction output unit
406 Authenticating/key-sharing unit
407 Input unit
1800 Personal computer
1801 CPU
1802 RAM
1803 EEPROM
1804 Display
1805 Speaker
1806 Large-capacity storage device
1807 Input/output interface
1808 Bus
1900 Recorder
1901 System chip
1901a CPU
1901b Coprocessor
1901c Interface function unit
1901d Bus
1902 Large-capacity storage device
1903 RAM
1904 EEPROM
1905 Wireless LAN chip
1906 Tuner
1907 Display
1908 Speaker
1909 LAN port
1909A LAN cable
2000 Network access server
2001 System chip
2001a CPU
2001b Coprocessor
2001c Interface function unit
2001d Bus
2002 Large-capacity storage device
2003 RAM
2004 EEPROM
2005 Wireless LAN chip
2006 LAN port
2006A LAN cable
2100 Computer program distribution system
2110 Server
2111 Storage device
2112 Communication device
2113 Information notification device

1. A content reception apparatus comprising:
a communication unit configured to communicate with a content transmission apparatus;
an authenticating unit configured to perform mutual authentication with the content transmission apparatus;
a content recording unit configured to record content; and
a content reproduction output unit configured to reproduce the content, wherein
the content is received from the content transmission apparatus and is recorded in the content recording unit after the authenticating unit performs first authentication with the content transmission apparatus, and the content recorded in the content recording unit is reproduced after the authenticating unit performs a process including second authentication with the content transmission apparatus.

2. The content reception apparatus according to claim 1, wherein the content recorded in the content recording unit is controlled not to be reproduced when an exchange key obtained through the process including the second authentication is not held.

3. The content reception apparatus according to claim 2, wherein the content is encrypted with a secret key unique to the content reception apparatus and is recorded in the content recording unit.

4. The content reception apparatus according to claim 1, wherein, when the content is received from the content transmission apparatus as a result of the first authentication performed by the authenticating unit, information to be used in a reproduction process after the process including the second authentication is performed is stored.

5. The content reception apparatus according to claim 4, wherein
first identification information of the content transmission apparatus is stored as the information to be used in the reproduction process, and
the authenticating unit performs the process including the second authentication with the content transmission apparatus having the stored first identification information.

6. The content reception apparatus according to claim 4, wherein
second identification information included in a device certificate received from the content transmission apparatus in the first authentication is stored as the information to be used in the reproduction process, and
the authenticating unit determines whether identification information included in a device certificate received from the content transmission apparatus in the second authentication is the same as the stored identification information.

7. The content reception apparatus according to claim 5, further comprising a content information acquiring unit configured to acquire content information including a URL of content and UI information useful for content selection, wherein
the URL of the content and the UI information are stored as the information to be used in the reproduction process.

8. The content reception apparatus according to claim 7, wherein the authenticating unit performs the process including the second authentication with the content transmission apparatus having the first identification information corresponding to the stored UI information.

9. The content reception apparatus according to claim 7, wherein the authenticating unit transmits the stored URL to the content transmission apparatus, a label of an exchange key obtained through the second authentication being added to the stored URL.

10. The content reception apparatus according to claim 9, wherein, when a response to the transmission of the URL is received from the content transmission apparatus within a predetermined period of time, reproduction of the content recorded in the content recording unit is started.

11. The content reception apparatus according to claim 1, wherein, when reproduction of the content recorded in the content recording unit is ended, the authenticating unit performs third authentication with the content transmission apparatus.

12. The content reception apparatus according to claim 4, wherein
the information to be used in the reproduction process includes a pointer to the content recorded in the content recording unit, and
the content of the pointer is reproduced after the process including the second authentication is performed.

13. The content reception apparatus according to claim 1, wherein, after the first authentication is performed, the content protected from copying is received from the content transmission apparatus in accordance with a move protocol.

14. A content reception method comprising:
performing first authentication with a content transmission apparatus;
receiving content from the content transmission apparatus; recording the received content;
performing a process including second authentication with the content transmission apparatus; and
reproducing the recorded content.

15. A content transmission apparatus comprising:
a communication unit configured to communicate with a content reception apparatus;
an authenticating unit configured to perform mutual authentication and shares an exchange key with the content reception apparatus;
a content providing unit configured to transmit the content encrypted with the exchange key from the communication unit to the content reception apparatus; and
a managing unit configured to store the exchange key and a label of the exchange key associated with identification information of the content reception apparatus, and stores a connection record including a lock flag indicating whether to discard the record of the exchange key and the label.

16. The content transmission apparatus according to claim 15, wherein
the content providing unit transmits the content to the content reception apparatus after the authenticating unit performs first authentication with the content reception apparatus, and
the lock flag in the corresponding connection record is set when the label of the exchange key shared with the content reception apparatus in the second authentication performed by the authenticating unit is received together with a URL of the content.

17. The content transmission apparatus according to claim 16, wherein
a duration of the content corresponding to the received URL is set in a timer for the connection record, the timer is prompted to count down, and
the managing unit resets the lock flag in the connection record when the value of the timer therein becomes zero.

18. The content transmission apparatus according to claim 16, wherein, when the authenticating unit performs third authentication with the content reception apparatus, the managing unit resets the lock flag in the corresponding connection record.

19. The content transmission apparatus according to claim 15, wherein, when a content transmission request including a label of an exchange key shared with the content reception apparatus in second authentication performed by the authenticating unit is received, the managing unit resets the lock flag in the corresponding connection record.

20. A content transmission method comprising:
performing first authentication with a content reception apparatus;
performing second authentication with the content reception apparatus by transmitting content to the content reception apparatus; and
setting a lock flag in a corresponding connection record when a label of an exchange key shared in the second authentication is received from the content reception apparatus.
